(19) United States
(12) Patent Application Publication
(10) Pub. No.: US 2013/0083086 A1
(43) Pub. Date: Apr. 4, 2013

(54) DISPLAY DEVICE AND DRIVE CONTROL METHOD OF DISPLAY ELEMENT

(71) Applicant: Masaki NOSE, Ebina (JP)

(72) Inventor: Masaki NOSE, Ebina (JP)

(73) Assignee: FUJITSU LIMITED, Kawasaki-shi (JP)

(21) Appl. No.: 13/548,318

(22) Filed: Jul. 13, 2012

(30) Foreign Application Priority Data
Sep. 29, 2011 (JP) 2011-215155

(51) Int. Cl. G09G 3/36; G09G 5/10; G09G 5/00

(52) U.S. Cl. 345/690; 345/204; 345/212; 345/208; 345/101

(57) ABSTRACT

A display device includes: a display element having memory properties; an electrostatic capacitance detection circuit; a temperature sensor detecting the temperature of the display element; and a control unit, wherein the control unit includes: a drive condition adjustment circuit configured to adjust the drive condition of the display element based on the electrostatic capacitance detected in the display state where the display element is driven under a predetermined drive condition; and a temperature compensation storage circuit storing one or more temperature compensation models indicating a correspondence relationship of the drive condition with which the display element has the optimum display characteristics across a predetermined temperature range, and the control unit changes the drive conditions of the display element at temperatures other than the temperature when the adjustment is performed based on: the temperature when the drive condition of the display element is adjusted; and the temperature compensation model.

### CROSS-REFERENCE TO RELATED APPLICATION

This application is based upon and claims the benefit of priority of the prior Japanese Patent Application No. 2011-215155, filed on Sep. 29, 2011, the entire contents of which are incorporated herein by reference.

### FIELD

The embodiments discussed herein are related to a display device and a drive control method of a display element.

### BACKGROUND

In recent years, a display element using a material having memory properties, such as cholesteric liquid crystal, has been developed and is applied to electronic paper etc. Electronic paper is manufactured by difficult manufacturing processes using a film substrate, and therefore, the contrast, brightness, gamma, etc., of the display element tend to vary between lots. After the manufacturing, there is a possibility of the change in the characteristics after long-term use of the display element. If there are such variations and secular change, there arises such a problem that it is not possible to produce a desirable display even by driving the display element under the same drive condition.

As a result, it has been proposed to automatically adjust the optimum drive condition by detecting variations between lots and the secular change.

For example, it has been proposed to adjust a desired display state by mounting a luminance sensor in the display element and detecting the actual display state. However, the mounting of the luminance sensor in the display element is problematic from the viewpoint of cost and external appearance and in particular, it is not preferable to mount a luminance sensor in a reflective display element which is easy to carry, such as electronic paper.

Further, measuring the accumulated energized time of a display element that is energized at all times during the period of display and to correcting by estimating the secular change is also carried out. However, the electronic paper is energized only when being rewritten and the energization is performed randomly, and therefore, the correction that makes use of the accumulated energized time is not applied to the electronic paper.

To drive a liquid crystal display element is to drive each pixel having an electrostatic capacitance and the drive condition is determined in accordance with the electrostatic capacitance value. Therefore, it is proposed to provide a dummy pixel and adjust the drive voltage by detecting the electrostatic capacitance value of the dummy pixel. However, the electrostatic capacitance of the dummy pixel does not agree with the electrostatic capacitance of an actual display pixel because of the difference in the drive history, and therefore, there is such a problem that the detection precision is not sufficient. Further, in the proposed method, the electrostatic capacitance value is detected by detecting the oscillation frequency of a CR oscillator circuit including dummy pixels. This detection method is practical when the specific resistance is high and the capacitance characteristics are stable, such as in a TFT liquid crystal display element, however, when the specific resistance is relatively low and the capacitance characteristics are unstable, such as the cholesteric liquid crystal having memory properties used in the electronic paper, the stability of the oscillator circuit is insufficient and it is not possible to detect the electrostatic capacitance with high precision.

It is known that the electrostatic capacitance of the liquid crystal display element changes in accordance with temperature. In other words, the electrostatic capacitance changes in accordance with temperature and in response to this, the drive condition changes accordingly. Therefore, it is proposed to obtain an excellent display at all times regardless of temperature by detecting the electrostatic capacitance of the display element and by adjusting the drive condition. However, this proposal takes into consideration only the adjustment in accordance with temperature but not variations or the secular change.

Further, it takes a long time to detect the electrostatic capacitance of the liquid crystal display element and to adjust the drive condition. The variations in the electrostatic capacitance of the liquid crystal display element, i.e., the difference in the electrostatic capacitance from that of the standard liquid crystal display element is made clear if once detected and the electrostatic capacitance of the liquid crystal display element does not change in a brief time. Therefore, the operation to detect the electrostatic capacitance and to adjust the drive condition are not frequently performed in order to correct the difference in the drive condition resulting from the variations in the electrostatic capacitance of the liquid crystal display element and the secular change. Therefore, it is not problematic if a certain period of time is consumed for the operation to adjust the drive condition. However, the temperature of the liquid crystal display element changes in a brief time, and therefore, it will bring such a problem that the substantial responsiveness of the display element is reduced if the operation to detect the electrostatic capacitance and to adjust the drive condition that takes a long time is performed each time the temperature changes.

### Related Documents

[Patent Document 1] Japanese Laid Open Patent Document No. 2008-065058
[Patent Document 2] Japanese Laid Open Patent Document No. S52-140295
[Patent Document 3] Japanese Laid Open Patent Document No. 2002-140047

### SUMMARY

According to a first aspect of the embodiment, a display device includes: a display element having memory properties configured to maintain a display state after being driven and then the drive is cancelled; an electrostatic capacitance detection circuit configured to detect an electrostatic capacitance exhibited by the display element; a temperature sensor configured to detect the temperature of the display element; and a control unit configured to control the drive of the display element, wherein the control unit includes: a drive condition adjustment circuit configured to adjust the drive condition of the display element based on the electrostatic capacitance detected in the display state where the display element is driven under a predetermined drive condition; and a temperature compensation storage circuit storing one or more temperature compensation models indicating a correspondence relationship of the drive condition with which the display element has the optimum display characteristics across a predetermined temperature range, and the control unit changes the drive conditions of the display element at temperatures other than the temperature when the adjustment is performed based on: the temperature when the drive condition of the display element is adjusted; and the temperature compensation model.

According to a second aspect of the embodiment, a drive control method of a display element having memory properties configured to maintain a display state after being driven and then the drive is cancelled, the method includes: detecting the electrostatic capacitance exhibited by the display element in a set display state after setting the display state by driving the display element under a predetermined drive condition; automatically adjusting the drive condition of the display element based on the detected electrostatic capacitance; detecting the temperature of the display element; and changing the drive conditions of the display element at temperatures other than the temperature when the adjustment is performed based on the detected temperature and a temperature compensation model.

The object and advantages of the embodiments will be realized and attained by means of the elements and combination particularly pointed out in the claims.

It is to be understood that both the foregoing general description and the following detailed description are exemplary and explanatory and are not restrictive of the invention.

### BRIEF DESCRIPTION OF THE DRAWINGS

FIG. 1 is a diagram schematically illustrating a configuration of a display device of a first embodiment.

FIG. 2 is a diagram illustrating a configuration of the display element 10 used in the display device of the first embodiment;

FIG. 3 is a diagram illustrating a configuration of one panel;

FIG. 4A and FIG. 4B are diagrams for explaining the states of the cholesteric liquid crystal;

FIG. 5 illustrates an example of the voltage-reflection characteristics of the general cholesteric liquid crystal;

FIG. 6 is a diagram illustrating a drive waveform in the DSS;

FIG. 7 is a diagram illustrating drive waveforms output from a common driver and a segment driver during the preparation period, the selection period, the evolution period, and the non-select period for the white display and the black display, and waveforms to be applied to the liquid crystal;

FIG. 8 is a diagram illustrating a voltage waveform in detail to be applied to each pixel;

FIG. 9 is a diagram illustrating the result of measurement of the relationship between the lightness (reflectance) and the electrostatic capacitance of five samples of the display element;

FIG. 10 is a diagram illustrating the frequency characteristics of electrostatic capacitance of the display element;

FIG. 11 is a diagram illustrating a configuration of a circuit part that outputs an electrostatic capacitance detection signal in a power source unit, a current sense amplifier, and an arithmetic unit;

FIG. 12 is a diagram illustrating a waveform of an electrostatic capacitance detection signal to be supplied to an unused power source terminal of a segment driver from a booster circuit via a damping resistor;

FIG. 13A and FIG. 13B illustrate detection signals of the electrostatic capacitance;

FIG. 14 is a diagram illustrating a change in a capacitance of a display element when an evolution voltage is changed;

FIG. 15A and FIG. 15B are diagrams explaining an adjustment method of a drive condition in the display device of the first embodiment;

FIG. 16 is a flowchart illustrating automatic adjustment processing of drive condition in the display device of the first embodiment;

FIG. 17A and FIG. 17B are diagrams illustrating examples of drive waveforms to bring all the pixels into white and black display states;

FIG. 18A and FIG. 18B are diagrams explaining the method for adjusting the evolution voltage so that the measured electrostatic capacitance value agrees with the target electrostatic capacitance value by the Newton's method;

FIG. 19 is a diagram illustrating changes in the evolution voltage when the Newton's method is performed on the electrostatic capacitances that change from C0′ to 10% and 90%;

FIG. 20A to FIG. 20C are diagrams explaining a method for adjusting an evolution voltage by dichotomy so that the measured electrostatic capacitance value agrees with the target electrostatic capacitance value;

FIG. 21 is a diagram explaining adjustment in third step S3 and illustrating a change in the electrostatic capacitance with respect to a duty ratio of a selection pulse;

FIG. 22 is a diagram explaining processing when third step S3 is performed using the dichotomy;

FIG. 23 is a diagram illustrating a change in a duty ratio when the dichotomy is performed;

FIG. 24 is a flowchart illustrating drive condition automatic adjustment processing that makes use of this search algorithm;

FIG. 25 is a diagram illustrating processing when the difference calculated in S82 is determined to be equal to or less than the second threshold value in step S83;

FIG. 26 is a diagram illustrating an example of the processing in step S9;

FIG. 27A and FIG. 27B are diagrams illustrating examples of divided screen and the connection of the segment driver to measure the electrostatic capacitance of different gradation levels at the same time;

FIG. 28A to FIG. 28D are diagrams illustrating an example of the display screen when measuring the electrostatic capacitance of the 16 kinds of gradations;

FIG. 29 is a diagram illustrating a correspondence relationship of output voltages of a segment driver and a common driver when using a bipolar driver IC;

FIG. 30 is a diagram illustrating an operation rewriting the display when the temperature changes from that at the time of the previous rewriting of the display;

FIG. 31 is a diagram illustrating drive condition adjustment processing in the first embodiment and an operation rewriting the display when the temperature changes;

FIG. 32 is a diagram illustrating the drive condition adjustment processing operation in the first embodiment;

FIG. 33 is a diagram illustrating a relationship between a change in temperature and a change in viscosity of the liquid crystal material;

FIG. 34 is a diagram illustrating a correspondence relationship between the viscosity of the liquid crystal material and the energy during the evolution period with which the highest contrast is obtained when the liquid crystal material is driven by the dynamic drive method;

FIG. 35 is a diagram illustrating a change with temperature in the relative value of the energy during evolution period when a high contrast is obtained of two liquid crystal display elements A and B in different manufacturing lots;

FIG. 36 is a diagram illustrating a relationship between the temperature and the voltage during the evolution period when the application time during the evolution period is fixed and the voltage during the evolution period is changed;

FIG. 37 is a diagram illustrating a relationship between the temperature and a duty ratio during the selection period with which the center gradation (=8/15) of the 16 gradations of green is obtained;

FIG. 38 is a diagram schematically illustrating changes in rewrite speed when temperature compensation is performed discretely and continuously;

FIG. 39 is a flowchart illustrating an operation when a display is produced in the display device of the first embodiment;

FIG. 40A and FIG. 40B are diagrams illustrating examples in which drive conditions in an entire temperature range are changed based on a temperature compensation model in the first embodiment;

FIG. 41A and FIG. 41B are diagrams illustrating changes in the display characteristics with respect to temperature in the display device of the first embodiment;

FIG. 42 is a diagram illustrating the change in gamma (gradation characteristics) with respect to temperature in the display device of the first embodiment;

FIG. 43 is a flowchart illustrating drive condition automatic adjustment processing of the display device of a second embodiment;

FIG. 44 is a diagram illustrating a change in display state in a display device of a third embodiment;

FIG. 45A is a diagram illustrating a reset pulse to be applied to all the pixels at the time of reset processing;

FIG. 45B is a diagram illustrating a write pulse when a first method is performed;

FIG. 46A to FIG. 46D are diagrams illustrating write pulses when the first method is performed.

### DESCRIPTION OF EMBODIMENTS

Embodiments are described with reference to the drawings.

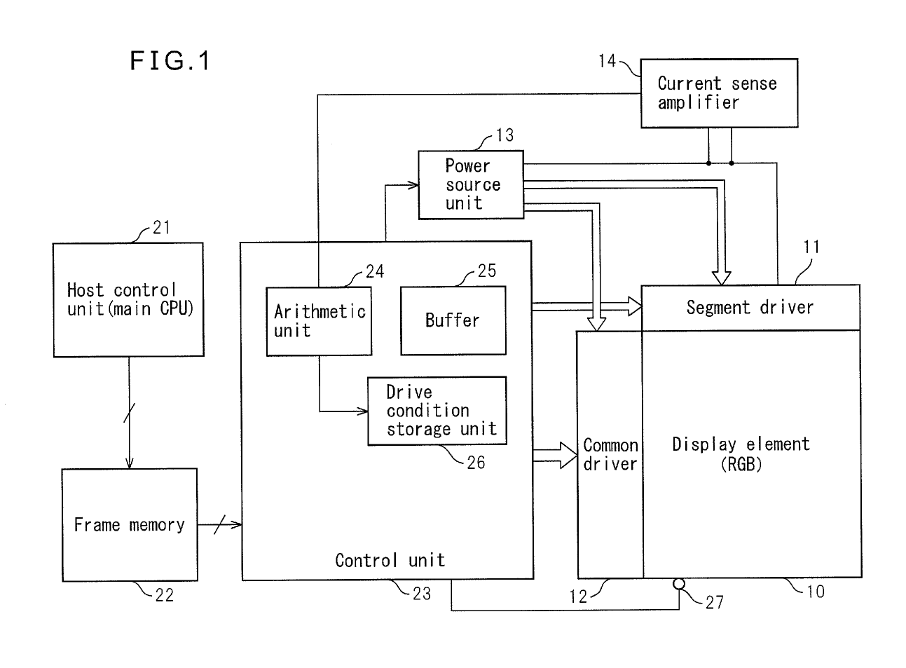

FIG. 1 is a diagram schematically illustrating a configuration of a display device of a first embodiment. The display device of the first embodiment is electronic paper. To a display element 10, a drive signal is applied only when the display is rewritten and the display once rewritten is maintained without the application of the drive signal.

As illustrated in FIG. 1, the display device of the first embodiment has the display element 10 using cholesteric liquid crystal, a segment driver 11, a common driver 12, a power source unit 13, a current sense amplifier 14, a host control unit 21, a frame memory 22, a control unit 23, and a temperature sensor 27 provided in close proximity to the display element.

The host control unit 21 has a main CPU etc. and performs various kinds of processing on image data stored in an external storage device, image data obtained via a communication circuit, etc., in order to form the images into those suitable for the display of the display device. For example, in order to display halftone image data, gradation conversion is performed by applying publicly-known gradation conversion, such as the error diffusion method, systematic dither method, and blue noise mask method, so that the number of gradations of the data agrees with the number of gradations that may be displayed by this display device. There is a case where part of the processing is performed in the control unit 23. The host control unit 21 stores the generated image data in the frame memory 22.

The control unit 23 has a sub CPU, microcontroller, or PLD and performs control of each unit except for the host control unit 21. The control unit 23 generates drive data in accordance with image data read from the frame memory 22 and supplies the data to the segment driver 11 and the common driver 12. It is desirable for the control unit 23 to have a buffer 25 to temporarily store the generated drive data in order to make easy the supply timing adjustment of the drive data to the segment driver 11 and the common driver 12. Further, the control unit 23 has a drive condition storage unit 26 configured to store the drive condition at each temperature in order to change the voltage and pulse width of a drive signal to be applied to the display element 10 in accordance with temperature by controlling the power source unit 13, the segment driver 11, and the common driver 12. The drive condition stored in the drive condition storage unit 26 is updated at any time, as will be described later.

The display element 10 is a display element using cholesteric liquid crystal and capable of producing a color display, in which three layer panels of RGB are stacked. Details of the display element 10 are described later. The segment driver 11 and the common driver 12 drive the display element 10 by the simple matrix system and are realized by a general-purpose driver IC. Here, the segment driver 11 includes three drivers and drives each layer panel independently, however, it is also possible for the common driver 12 to drive the three layer panels in common by one driver.

The power source unit 13 steps up a voltage of 3 to 5 V supplied from a common power source, not illustrated schematically, of the display device to +50 V in the case of an unipolar driver IC by a step-up regulator, such as a DC-DC converter, or to about −25 V to +25 V in the case of a bipolar driver IC by using also a negative DC-DC converter. It is naturally desirable for the step-up regulator to have high conversion efficiency for the characteristics of the display element. It is desirable to perform switching of a reset voltage and a write voltage by using an analog switch, a digital potentiometer, etc. In the post stage of the switching circuit, for the stability of the drive voltage of the display element 10, a booster circuit including an operational amplifier and a transistor, and a smoothing capacitor are arranged.

The configuration explained above is the same as that of a general display device using cholesteric liquid crystal and various kinds of configurations known hitherto may be applied. The display element 10 is not limited to the display device using cholesteric liquid crystal and any display element having memory properties may be used.

In the display device of the first embodiment, the power source unit 13 generates an electrostatic capacitance detection signal, such as a saw-tooth wave signal and a triangular signal, in response to a control signal from the control unit 23 and supplies the electrostatic capacitance detection signal to the power source terminal of the segment driver 11. It is preferable to use a part not used for write as the power source terminal. Further, it is possible for the power source unit 13 to adjust the voltage to be supplied to the segment driver 11 and the common driver 12 in response to a control signal from the control unit 23.

In the display device of the first embodiment, the current sense amplifier 14 is further arranged to detect a current of a signal line that supplies the electrostatic capacitance detection signal from the power source unit 13 to the segment driver 11. The current detected when the electrostatic capacitance detection signal is applied to the display element 10 relates to the electrostatic capacitance of the display element 10 and the current sense amplifier 14 outputs the detection signal to an arithmetic unit 24 within the control unit 23. Further, the control unit 23 reads the temperature of the display element 10 detected by the temperature sensor 27 provided in close proximity to the display element 10.

The control unit 23 performs the drive condition adjustment mode when the display device is started or in response to a user's specification. It may also be possible to automatically perform the drive condition adjustment mode without fail when the display device is used for the first time, for example, when the product is shipped, and after that, to automatically perform periodically, for example at a frequency of once a month. After setting the display element 10 to a predetermined display state, the control unit 23 applies the electrostatic capacitance detection signal from the power source unit 13 to the display element 10 and controls the arithmetic unit 24 to digitalize the detection signal of the current sense amplifier 14 and to take in as detection data. The control unit 23 acquires the detection data while changing the display state of the display element 10 according to a drive condition adjustment sequence, which is described later, and determines the drive condition under which a desired display may be produced. After the drive condition adjustment mode is completed, the control unit 23 reads the temperature of the display element 10 detected by the temperature sensor 27 and determines the drive conditions at temperatures other than the detected temperature based on the detected temperature and a temperature compensation model, which is described later. Then, the control unit 23 updates the drive conditions of all of the temperatures stored in the drive condition storage unit 26 with the determined drive conditions. After that, the control unit 23 controls each unit according to the drive condition stored in the drive condition storage unit 26

Next, the display device using cholesteric liquid crystal used as the display element 10 in the display device of the first embodiment is explained.

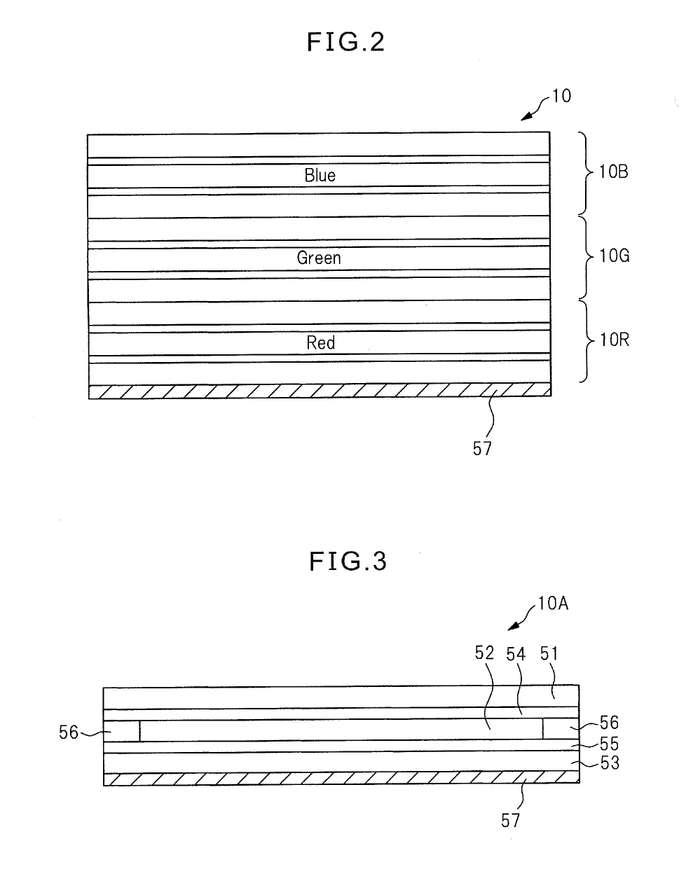

FIG. 2 is a diagram illustrating a configuration of the display element 10 used in the display device of the first embodiment. As illustrated in FIG. 2, in the display element 10, three panels, i.e., a blue panel 10B, a green panel 10G, and a red panel 10R are stacked in the order from the viewing side and under the red panel 10R, a light absorbing layer 57 is provided. The panels 10B, 10G, and 10R have the same configuration, however, the liquid crystal material and the chiral material are selected and the content percentage of the chiral material is determined so that the center wavelength of reflection of the panel 10B is blue (about 480 nm), the center wavelength of reflection of the panel 10G is green (about 550 nm), and the center wavelength of reflection of the panel 10R is red (about 630 nm). The scan electrode and the data electrode of the panels 10B, 10G, and 10R are driven by the common driver 12 and the segment driver 11.

The panels 10B, 10G, and 10R have the same configuration except in that the center wavelengths of reflection are different. Hereinafter, a typical example of the panels 10B, 10G, and 10R is represented by a panel 10A and its configuration is explained.

FIG. 3 is a diagram illustrating a fundamental configuration of one panel 10A.

As illustrated in FIG. 3, the display element 10A has an upper side substrate 51, an upper side electrode layer 54 provided on the surface of the upper side substrate 51, a lower side electrode layer 55 provided on the surface of a lower side substrate 53, and a sealing material 56. The upper side substrate 51 and the lower side substrate 53 are arranged so that their electrodes are in opposition to each other and after a liquid crystal material is sealed therebetween, they are sealed with sealing material 56. Within a liquid crystal layer 52, a spacer is arranged, however, it is not illustrated schematically. To the electrodes of the upper side electrode layer 54 and the lower side electrode layer 55, a voltage pulse signal is applied, and thereby, a voltage is applied to the liquid crystal layer 52. A display is produced by applying a voltage to the liquid crystal layer 52 to bring the liquid crystal molecules of the liquid crystal layer 52 into the planar state or the focal conic state. A plurality of scan electrodes and a plurality of data electrodes are formed in the upper side electrode layer 54 and the lower side electrode layer 55.

Both the upper side substrate 51 and the lower side substrate 53 have transparency, however, the lower side substrate 53 of the panel 10R does not need to be transparent. As a substrate having transparency, there is a glass substrate, however, a film substrate, such as PET (polyethylene terephthalate) and PC (polycarbonate), may be used in addition to the glass substrate.

As the material of the upper side electrode layer 54 and the lower side electrode layer 55, for example, indium tin oxide (ITO) is typical, however, it is possible to use a transparent conductive film, such as indium zinc oxide.

The transparent electrode of the upper side electrode layer 54 is formed as a plurality of upper side transparent electrodes in the shape of a band in parallel to each other on the upper side substrate 51 and the transparent electrode of the lower side electrode layer 55 is formed as a plurality of lower side transparent electrodes in the shape of a band in parallel to each other on the lower substrate 53. Then, the upper side substrate 51 and the lower side substrate 53 are arranged so that the upper electrode and the lower electrode intersect when viewed in a direction perpendicular to the substrate and pixels are formed at the intersections. On the electrode, an insulating thin film is formed. When this thin film is thick, the drive voltage is increased. Conversely, if there is no thin film, a leak current flows and there arises such a problem that the precision of the automatic adjustment of the present invention is reduced. The specific dielectric coefficient of the thin film is about 5, considerably smaller than that of liquid crystal, and therefore, it is suitable to set the thickness of the thin film to 0.3 μm or less.

The insulating thin film may be realized by a SiO₂ thin film or an organic film, such as polyimide resin and acryl resin, known as an orientation stabilizing film.

As described above, within the liquid crystal layer 52, a spacer is arranged and the distance between the upper side substrate 51 and the lower side substrate 5, that is, the thickness of the liquid crystal layer 52 is made constant. In general, the spacer is spherical object made of resin or inorganic oxide, however, it is also possible to use a fixed spacer obtained by coating a thermoplastic resin on the substrate surface. An appropriate range of the cell gap formed by the spacer is 4 μm to 6 μm. When the cell gap is smaller than this value, the reflectance is reduced and the display becomes dark and high threshold value steepness is not expected. On the contrary, if the cell gap is larger than this value, the high threshold value steepness may be kept, however, the drive voltage is raised and the drive by a general-purpose part is made difficult.

The liquid crystal composite that forms the liquid crystal layer 52 is cholesteric liquid crystal, which is a nematic liquid crystal mixture to which a chiral material of 10 to 40 weight percent (wt %) is added. The amount of added chiral material is the value when the total amount of the nematic liquid crystal component and the chiral material is assumed to be 100 wt %.

As the nematic liquid crystal, various kinds publicly known conventionally may be used, however, it is desirable to use a liquid crystal material the dielectric constant anisotropy (Δ∈) of which is in the range of 15 to 35. When the dielectric constant anisotropy is 15 or less, the drive voltage is raised as a whole and it becomes difficult to use a general-purpose circuit in the drive circuit.

On the other hand, when the dielectric constant anisotropy becomes 25 or more, the threshold value steepness is reduced and further there is a possibility that the reliability of the liquid crystal material itself is reduced.

It is desirable for the refractive index anisotropy (Δn) to be 0.18 to 0.24. When the refractive index anisotropy is smaller than this range, the reflectance in the planar state is reduced and when the refractive index anisotropy is larger than this range, the scattering reflection in the focal conic state increases and in addition thereto, the viscosity becomes high and the response speed is reduced.

Next, the bright/dark (black/white) display in the display device using the cholesteric liquid crystal material is explained. The display device using the cholesteric liquid crystal controls a display by the orientation state of the liquid crystal molecules.

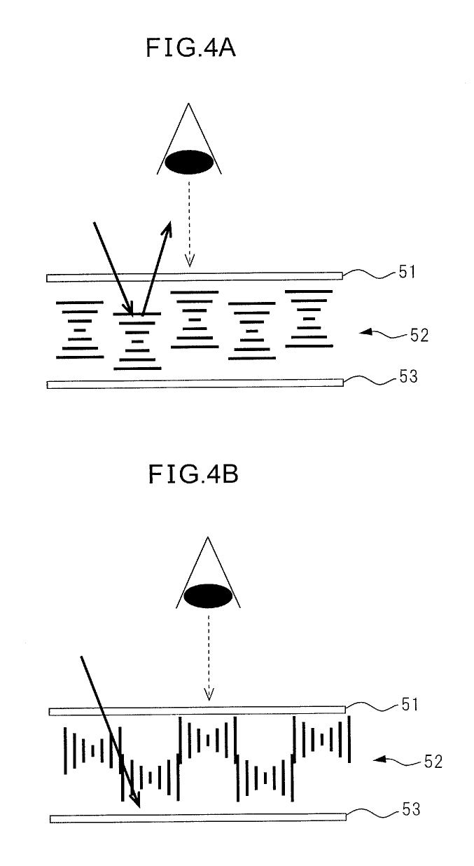

FIG. 4A and FIG. 4B are diagrams for explaining the states of the cholesteric liquid crystal. The cholesteric liquid crystal has a planar state that reflects incident light as illustrated in FIG. 4A and a focal conic state that transmits incident light as illustrated in FIG. 4B, and these states may be kept stably with no electric field. In addition to those, there is a homeotropic state in which all the liquid molecules align in the direction of an electric field when a strong electric field is applied. The homeotropic state makes a transition to the planar state or the focal conic state when the application of the electric field is stopped.

At the time of the planar state, the cholesteric liquid crystal reflects light having a wavelength in accordance with the helical pitch of the liquid crystal molecules. A wavelength 2 at which the reflectance is at its maximum is expressed by the following equation

λ=n·p

wherein n is an average refractive index and p is a helical pitch.

On the other hand, the reflection band Δλ increases as the refractive index anisotropy Δn of the liquid crystal increases.

At the time of the planar state, incident light is reflected, and therefore, it is possible to display the “bright” state, i.e., white. On the other hand, at the time of the focal conic state, by providing a light absorbing layer under the lower side substrate 53, light having passed through the liquid crystal layer is absorbed, and therefore, it is possible to display the “dark” state, i.e., black. The state where the planar state and the focal conic state exist mixedly is a halftone state between the “bright” state (white display) and the “dark” state (black display) and the halftone level is determined by the ratio of mixture of the planar state and the focal conic state.

Next, the drive method of a display element using the cholesteric liquid crystal is explained.

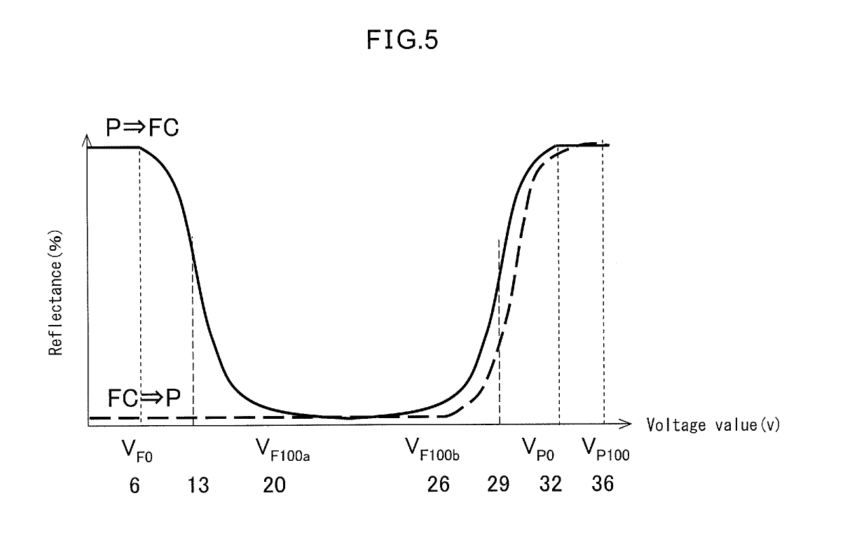

FIG. 5 illustrates an example of the voltage-reflection characteristics of the general cholesteric liquid crystal. The horizontal axis represents the voltage value (V) of the pulse voltage applied with a predetermined pulse width between electrodes sandwiching the cholesteric liquid crystal and the vertical axis represents the reflectance (%) of the cholesteric liquid crystal. A solid line curve P illustrated in FIG. 5 illustrates the voltage-reflection characteristics of the cholesteric liquid crystal when the initial state is the planar state and a broken line curve FC illustrates the voltage-reflection characteristics of the cholesteric liquid crystal when the initial state is the focal conic state.

When a strong electric field (V_{P100} or more) is caused to occur in the cholesteric liquid crystal, the helical structure of the liquid crystal molecules is completely undone during the application of the electric field and the homeotropic state is brought about where all the molecules align in accordance with the direction of the electric field. Next, when the liquid crystal molecules are in the homeotropic state, if the applied voltage is reduced abruptly from V_{P100} to substantially zero, the helical axis of the liquid crystal becomes perpendicular to the electrode and the planar state is brought about where light in correspondence to the helical pitch is reflected selectively.

On the other hand, when an electric field (in the range from V_{F100a} to V_{F100b) that does not undo the helical structure of the cholesteric liquid crystal molecules is applied and then the electric field is removed or when a strong electric field is applied and then the electric field is removed gradually from that state, the helical axis of the cholesteric liquid crystal molecules becomes parallel to the electrode and the focal conic state is brought about where incident light is transmitted.}

Further, when an electric field having an intermediate strength (V_{F0} to V_{F100a} or V_{F100b} to V_{VP}0) is applied and then the electric field is removed abruptly, a state is brought about where the planar state and the focal conic state exist mixedly and it is possible to produce a halftone image display.

A display is produced by making use of the above phenomena.

In the simple matrix display device using the cholesteric liquid crystal, when performing high-speed rewrite, the dynamic driving scheme (DDS) is used. The display device of the first embodiment also produces of a halftone image by the DDS. It may also be possible to perform the reset operation to bring all the pixels into the planar state at the same time before performing rewrite. The reset operation is performed by forcedly setting all the outputs of the segment driver 11 and the common driver 12 to specified voltage values, respectively, and the transfer of data to set the output value is performed, and therefore, it is possible to perform the reset operation in a brief time. However, the reset operation consumes power, and therefore, it is not appropriate for a device with low power consumption to perform the reset operation.

In order to make explanation easy, first, a case is explained where a two-valued image of black and white is displayed.

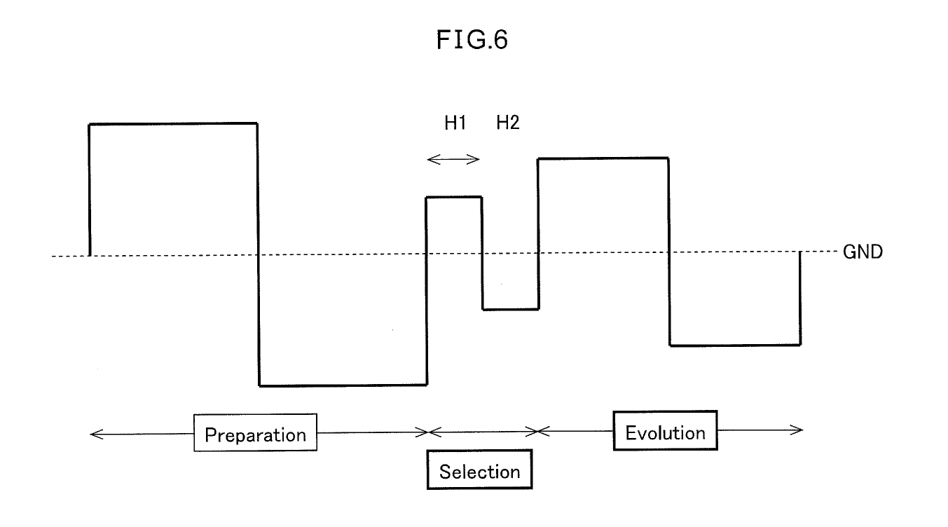

FIG. 6 is a diagram illustrating a drive waveform in the DSS.

As described previously, the DDS is roughly divided into three stages and includes, from the front, the preparation period, the selection period, and the evolution period. Before and after these periods, the non-select period is provided. The preparation period is a period during which the liquid crystal is initialized into the homeotropic state and a high-voltage preparation pulse with a great pulse width is applied. The selection period is a period during which branching of the state into the planar state or into the focal conic state is triggered. During the selection period, when the state is switched to the planar state, a low-voltage selection pulse with a small pulse width is applied and when switched to the focal conic state, no pulse is applied. The evolution period is a period during which the state is settled to the planar state or to the focal conic state in accordance with the transition state during the immediately previous selection period and an intermediate-voltage evolution pulse with a great pulse width is applied. The preparation pulse, the election pulse, and the evolution pulse are each a pair of positive and negative pulses.

Actually, during the preparation period and the evolution period, a pair of positive and negative pulses with a great pulse width as in FIG. 6 is not applied but a plurality of positive and negative preparation pulses and a plurality of positive and negative evolution pulses are applied.

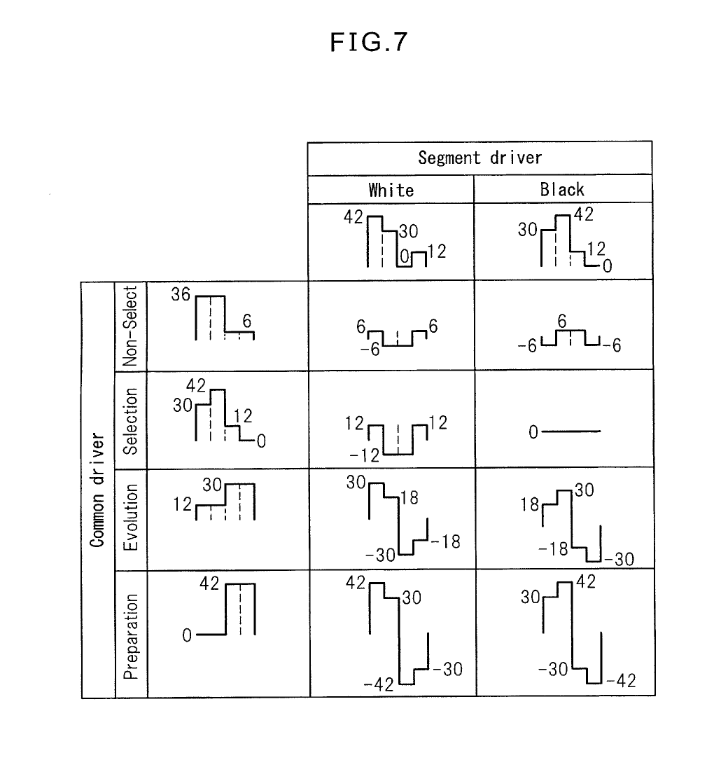

FIG. 7 illustrates drive waveforms the common driver 12 outputs during the preparation period, the selection period, the evolution period, and the non-select period, drive waveforms the segment driver 11 outputs for the white display and the black display, and waveforms to be applied to the liquid crystal (applied waveforms).

When the DDS is performed in the first embodiment, the common driver 12 outputs seven values including GND and the segment driver 11 outputs five values including GND. At present, a general-purpose driver IC for the simple matrix system is put to practical use, and therefore, it is possible to use the general-purpose driver as the segment driver 11 or the common driver 12 by setting the mode. Consequently, there are values to be output left unused in the general-purpose driver IC made use of as the segment driver 11. In the first embodiment, by making use of the output left unused of the segment driver 11, an electrostatic capacitance detection signal is applied to the display element 10.

The common driver 12 and the segment driver 11 change the output in units of periods, which are the selection periods equally divided into four. The segment driver 11 outputs a voltage waveform that changes to 42 V, 30 V, 0 V, and 12 V for the white display and a voltage waveform that changes to 30 V, 42 V, 12 V, and 0 V for the black display. The common driver 12 outputs a voltage waveform that changes to 36 V, 36 V, 6 V, and 6 V during the non-select period, a voltage waveform that changes to 30 V, 42 V, 12 V, and 0 V during the selection period, a voltage waveform that changes to 12 V, 12 V, 30 V, and 30 V during the evolution period, and a voltage waveform that changes to 0 V, 0 V, 42 V, and 42 V during the preparation period.

Due to this, during the preparation period, a voltage waveform that changes to 42 V, 30 V, −42 V, and −30 V is applied to the liquid crystal of the data electrode of the white display and a voltage waveform that changes to 30 V, 42 V, −30 V, and −42 V is applied to the liquid crystal of the data electrode of the black display. During the evolution period, a voltage waveform that changes to 30 V, 18 V, −30 V, and −18 V is applied to the liquid crystal of the data electrode of the white display and a voltage waveform that changes to 18 V, 30 V, −18 V, and −30 V is applied to the liquid crystal of the data electrode of the black display. During the selection period, a voltage waveform that changes to 12 V, −12 V, −12 V, and 12 V is applied to the liquid crystal of the data electrode of the white display and a voltage waveform of 0 V is applied to the liquid crystal of the data electrode of the black display. During the non-select period, a voltage waveform that changes to 6 V, −6 V, −6 V, and 6 V is applied to the liquid crystal of the data electrode of the white display and a voltage waveform that changes to −6 V, 6 V, 6 V, and −6 V is applied to the liquid crystal of the data electrode of the black display.

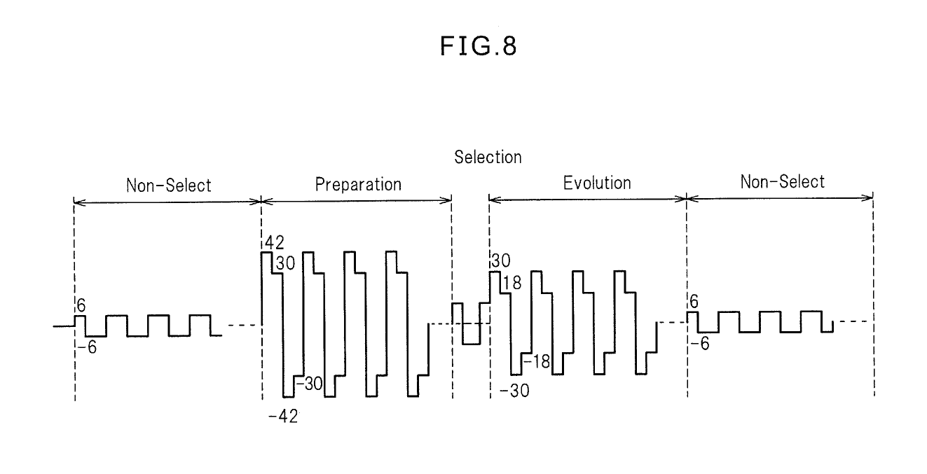

FIG. 8 is a diagram more specifically illustrating a voltage waveform to be applied to each pixel liquid crystal as a result of that the common driver 12 and the segment driver 11 output the drive waveforms illustrated in FIG. 7. The voltage waveform of FIG. 8 is applied to one scan line. The common driver 12 shifts the scan line one by one to which the signal of FIG. 8 is applied.

As illustrated in FIG. 8, the preparation period, the selection period, and the evolution period are arranged in this order and before and after these periods, the non-select period is arranged. During the selection period, the application time is about 0.5 ms to 1 ms. FIG. 8 illustrates the selection pulse of ±12 V when the white display (bright display) is produced in the planar state and when the black display (dark display) is produced in the focal conic state, 0 V is applied during this period.

The lengths of the preparation period and the evolution period are about several times to tens of times the length of the selection period and a plurality of the preparation pulses and evolution pulses of FIG. 7 is applied. The non-select pulse is a pulse applied at all times to pixels not involved with drawing and has a low voltage, and therefore, does not change an image.

A set of the preparation pulse, the selection pulse, and the evolution pulse of FIG. 8 is applied sequentially while changing the position of the scan line. Due to this, the selection pulse, together with the preparation pulse and the evolution pulse, performs scan/rewrite in a pipeline manner with the application time of the selection pulse per line. Therefore, it is possible to perform rewrite in about 1 ms×768=0.77 sec even in the display element of high precision size of XGA specifications.

When displaying a halftone image, the configuration is designed so that the drive waveforms illustrated in FIG. 7 may be applied during each sub period by further dividing the selection period into a plurality of sub periods. Of the plurality of sub periods, the ratio between the sub periods during which the white display is produced to the sub periods during which the black display is produced is changed. For example, in the case where eight sub periods are provided, when the white display is produced during all the eight sub periods, the duty ratio is 100%, when the black display is produced during all the eight sub periods, the duty ratio is 0%, and when the white display is produced during two sub periods, the duty ratio is 25%, In the first embodiment, the preparation period is about 700 μs and divided into sub periods of 20 to 30 μs. Consequently, 23 to 35 sub periods are provided. During the selection period, if the sub period of the white display is arranged in the center, the width of the selection pulse of the white display during the selection period varies according to the duty ratio as a result. In the following, to simplify explanation, explanation is given on the assumption that the DDS drive waveforms illustrated in FIG. 6 are used and the width of the selection pulse during the selection period varies according to the duty ratio.

As described previously, in the display device using liquid crystal having memory properties, the contrast, brightness, gamma, etc., of the display element tend to vary between lots and there is a possibility of the change of such characteristics due to a long-term use of the display element. If there are variations and secular change of the display element, it is not possible to produce a desirable display even if the display element is driven under the same drive condition. In particular, the DDS used in the display device of the first embodiment has a narrow optimum range of the drive condition and is considerably affected by the variations and secular change of the display element, and therefore, it is not possible to produce an excellent display under the fixed drive condition.

The drive condition is adjusted by detecting the characteristics of the display element in relation to the display (lightness) and based on the relationship with the display (lightness) of the detected characteristics. As described previously, it has been proposed to determine the drive condition in accordance with the electrostatic capacitance value hitherto and in the display device of the first embodiment also, the electrostatic capacitance of the display element 10 is detected and the drive condition is adjusted so that the desirable drive condition is realized. However, in the display device of the first embodiment, the dummy cell is not used and the detection of the electrostatic capacitance and the adjustment of the drive condition are performed by directly detecting the electrostatic capacitance of the display element and at the same time, by setting the display element 10 to a predetermined display state (white, black, or halftone level).

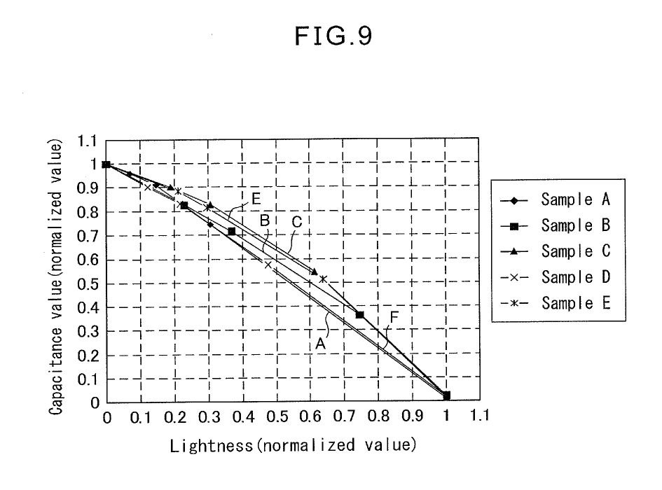

FIG. 9 is a diagram illustrating the result of measurement of the relationship between the lightness (reflectance) and the electrostatic capacitance of five samples of the display element 10. The electrostatic capacitance is a relative value obtained by performing measurement at 1 kHz and normalizing the lightness in the perfect planar state to 1 and the lightness in the perfect focal conic state to 0. An electrostatic capacitance value between 0 and 1 corresponds to a state where the planar state and the focal conic state exist mixedly and a halftone is displayed.

As is obvious from FIG. 9, the electrostatic capacitance is at its maximum at the time of the focal conic state (lightness 0) and the electrostatic capacitance decreases monotonically as the planar state (lightness 1) is reached. From this, it is known that the change in the lightness due to the variations and secular change may be estimated based on the relative relationship of the electrostatic capacitance when a desired display is not obtained because of the variations between lots and secular change. Therefore, in the display device of the first embodiment, the drive condition is adjusted by making use of such characteristics that the lightness and electrostatic capacitance of the cholesteric liquid crystal change very monotonically as illustrated in FIG. 9. Specifically, the electrostatic capacitance of the display element 10 is measured and the drive condition is adjusted based on the measured electrostatic capacitance.

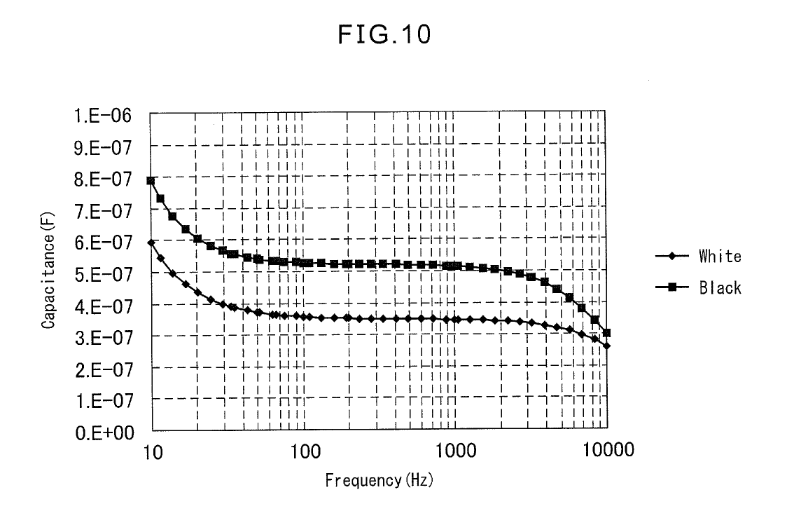

FIG. 10 is a diagram illustrating the frequency characteristics of electrostatic capacitance of the display element 10. In FIG. 10, the phenomenon in which the electrostatic capacitance is larger in the focal conic state than that in the planar state lasts until about 10 kHz is reached. Further, at the frequencies equal to or less than 100 Hz, the absolute value of the electrostatic capacitance becomes large. This may be considered because polarization due to the polar groups and ion components included in the liquid crystal material occurs. When the ratio of the electrostatic capacitance between the planar state and the focal conic state and the amount of current to be detected are taken into consideration, it may be thought that the use of a frequency near 1 kHz is preferable to detect the electrostatic capacitance.

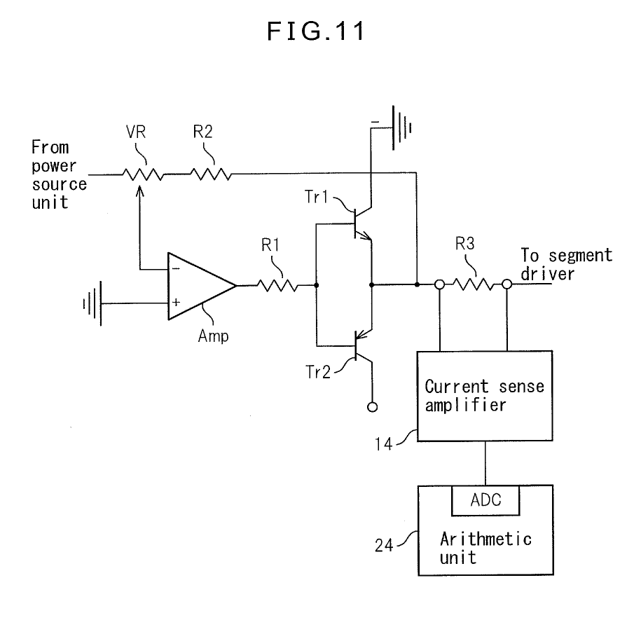

FIG. 11 is a diagram illustrating the configuration of a circuit part that outputs an electrostatic capacitance detection signal in the power source unit 13, the current sense amplifier 14, and the arithmetic unit 24. It is possible to use a general-purpose one very available as the current sense amplifier 14. The power source unit 13 generates a saw-tooth wave and a triangular wave by using a D/A converter, etc., not illustrated schematically, and applies an original detection signal to one end of a variable resister VR. A booster circuit having an operational amplifier Amp, a resistor R1, and transistors Tr1 and Tr2 and a resistor R2 form an amplifier circuit that amplifies the original detection signal and outputs an electrostatic capacitance detection signal and stabilize the output voltage. It is possible to adjust the amplification factor of the amplifier circuit by adjusting the resistance value of the variable resistor VR. It is possible to adjust the resistance value of the variable resistor VR by adjusting, for example, the number of resistors connected by a switch and the variable resistor VR is adjusted by the control signal, etc., from the control unit 23. When the wave height of the electrostatic capacitance detection signal is not adjusted, the variable resistor VR may be a fixed resistor. In the post stage of the booster circuit, a damping resistor R3 that restricts an electric current is arranged. In FIG. 11, the damping resistor R3 is used also as a sensing resistor of the current sense amplifier 14. As described previously, one end of the damping resistor R3 is connected to the unused power source terminal of the segment driver 11.

As the current sense amplifier 14, that which outputs the detected current value as an analog voltage value is used. The voltage of the voltage signal output from the current sense amplifier 14 is converted into a digital value by an AD converter (ADC) within the arithmetic unit 24 and used for the calculation of the electrostatic capacitance value. If a low-pass filter having an appropriate cut-off frequency is provided between the output of the current sense amplifier 14 and the AD converter, the detection precision is further improved.

The power source unit 13 generates voltages to be supplied to the segment driver 11 and the common driver 12 by a voltage divider circuit. Because the instantaneous current consumption is large in the DDS drive system, it is desirable for each voltage formed by the voltage divider circuit of the power source unit 13 to be output via the booster circuit having the operational amplifier Amp and the transistors Tr1 and Tr2 illustrated in FIG. 11.

Further, in many cases, at the terminal part of the power source unit 13 that outputs voltages to be supplied to the segment driver 11 and the common driver 12, a smoothing capacitor having a capacitance of about several microfarads is used in the post stage of the damping resistor. However, it is desirable to provide no such smoothing capacitor at the terminal that outputs the electrostatic capacitance detection signal illustrated in FIG. 11. The reason is that when such a smoothing capacitor is provided, the combined capacitance of the electrostatic capacitance of the display element and the capacitance of the smoothing capacitor is detected as a result, and therefore, the difference in the detected value of the electrostatic capacitance between the white display, the black display, and the halftone display becomes small, the S/N ratio is reduced, and the detection precision is reduced.

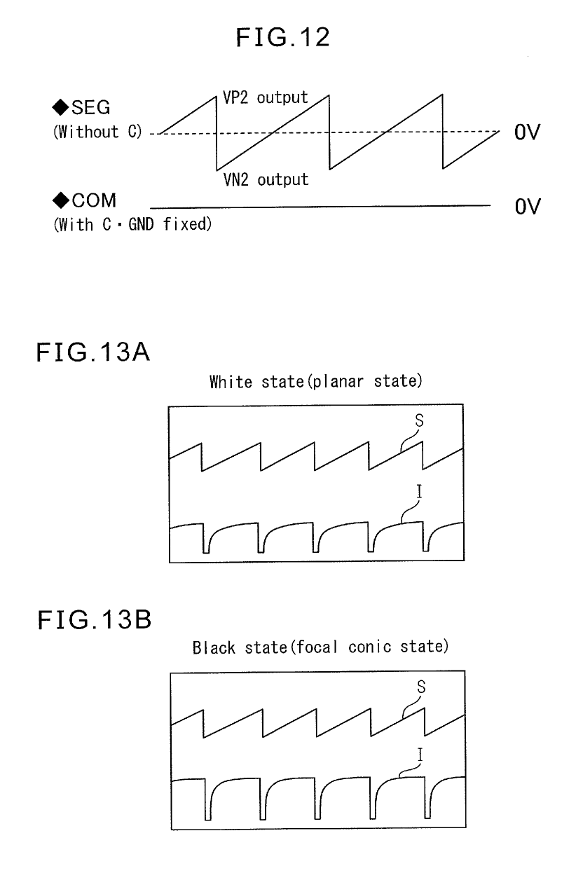

FIG. 12 is a diagram illustrating a waveform of an electrostatic capacitance detection signal to be supplied to the unused power source terminal of the segment driver 11 from the booster circuit via the damping resistor R3. In the first embodiment, an electrostatic capacitance detection signal in the shape of a saw-tooth wave the voltage of which changes between ±5 V is used. When applying the electrostatic capacitance detection signal to the display element, the setting is done so that the common driver 12 outputs the GND level to all the terminals and the segment driver 11 outputs the voltage of the terminal to which the electrostatic capacitance detection signal is applied. In this state, when the electrostatic capacitance detection signal is changed as illustrated in FIG. 12, the voltage that changes in the shape of a saw-tooth wave is applied to all the pixels of the display element 10. In general, the electrostatic capacitance detection signal in the shape of a saw-tooth wave is generated by a DA converter, and therefore, it is desirable to provide a low-pass filter having an appropriate cut-off frequency to smooth the signal.

The electrostatic capacitance is detected by the sense amplifier 14 detecting the current value at the time of charge/discharge accompanying the application of the electrostatic capacitance detection signal to the display element 10.

It has been found that it is possible to stably detect the current at the time of charge/discharge by using the electrostatic capacitance detection signal in the shape of a saw-tooth wave even in the case of the cholesteric liquid crystal the capacitance characteristics of which are poorer than those of the TFT liquid crystal.

FIG. 13A and FIG. 13B illustrate the result of the experiment of the detection of the electrostatic capacitance with the circuit configuration of FIG. 11 by using a test cell of cholesteric liquid crystal. FIG. 13A illustrates a saw-tooth-wave-shaped electrostatic capacitance detection signal S and an accompanying current I at the time of charge/discharge when all the pixels are in the white display state (planar state). FIG. 13B illustrates the saw-tooth-wave-shaped electrostatic capacitance detection signal S and the accompanying current I at the time of charge/discharge when all the pixels are in the black display state (focal conic state). In FIG. 13, the current I increases abruptly as the signal S increases and becomes substantially constant. When the current I becomes constant, the ratio between the current value in the focal conic state and the current value in the planar state is about 1.4 and it has been confirmed that the ratio substantially agrees with the ratio of electrostatic capacitance between the white and black displays illustrated in FIG. 10.

Further, a CR oscillator circuit was formed as a trial by replacing the test cell with a capacitor and the oscillation frequency was measured. As a result, the oscillation frequency in the planar state was about 1.4 times that in the focal conic state, however, such a case occurred frequently where the oscillation frequency varied considerably and was unstable. Consequently, in the case of the cholesteric liquid crystal, it was possible to detect the electrostatic capacitance by the current at the time of charge/discharge by applying the saw-tooth-wave-shaped electrostatic capacitance detection signal more stably than when detecting the electrostatic capacitance by detecting the oscillation frequency.

In the detection of the electrostatic capacitance described above, the electrostatic capacitances of the display element 10 at the time of the white/black displays were detected, however, it is possible to detect the electrostatic capacitance in the halftone display state by setting the display element 10 to the halftone display state. Further, in the detection of the electrostatic capacitance described above, the saw-tooth-wave-shaped electrostatic capacitance detection signal was used, however, it was also possible to perform measurement by using a triangular-wave-shaped electrostatic capacitance detection signal.

Next, the adjustment method of the drive condition in the display device of the first embodiment is explained.

When adjusting the drive condition of the DDS drive system, the conditions that may be adjusted are the voltages of the preparation pulse and the evolution pulse, the voltage of the white display of the selection pulse, the pulse width (duty ratio) of the selection pulse, etc. In the first embodiment, the voltage of the evolution pulse (evolution voltage) and the duty ratio of the selection pulse are adjusted. The reason the evolution voltage is adjusted is that the evolution voltage is a factor that affects contrast significantly. The reason the duty ratio of the selection pulse is adjusted is that the duty ratio is comparatively easy to adjust and fine adjustment may be performed of the factors that cause the change in gradation.

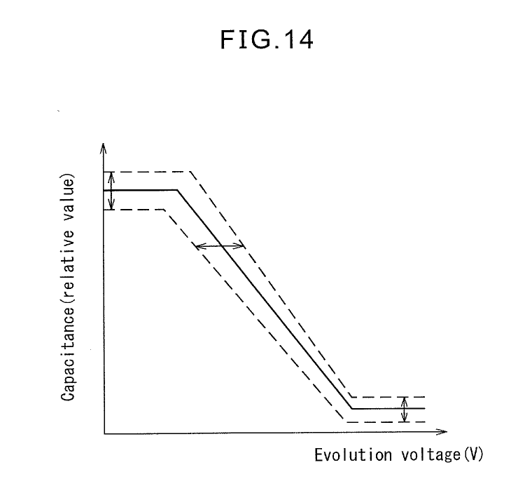

FIG. 14 is a diagram illustrating the change in the capacitance of the display element when the evolution voltage is changed in the case where the display element is driven by the DDS drive system under the drive condition explained with reference to FIG. 6 to FIG. 8 and the duty ratio of the selection pulse is set to a predetermined value (for example, 50%).

In FIG. 14, the solid line schematically illustrates an example of a change in one display element. When the display element is driven by the evolution voltage lower than a certain value, the electrostatic capacitance of the display element 10 after being driven is large and a constant value. As the evolution voltage is raised, the electrostatic capacitance of the display element 10 after being driven is reduced and when the evolution voltage becomes higher than a certain value, the electrostatic capacitance of the display element 10 after being driven becomes a small constant value. Such a change in capacitance varies due to the variations and secular change. For example, the value of the electrostatic capacitance that becomes constant on the high voltage side and the low voltage side varies vertically, the change in the middle part varies with respect to the evolution voltage (in the transverse direction in FIG. 14), and the slope of the change in the middle part also varies.

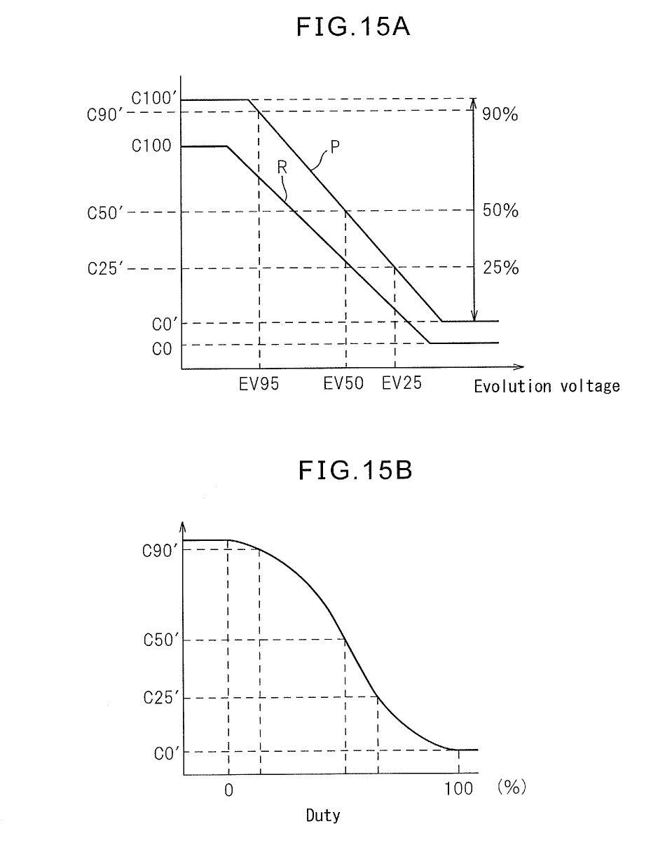

FIG. 15A and FIG. 15B are diagrams explaining the adjustment method of the drive condition in the display device of the first embodiment. FIG. 15A explains the adjustment in the first stage and in the second stage and FIG. 15B explains the adjustment in the third stage.

In FIG. 15A, R represents a typical example of the change in capacitance of the display element when the evolution voltage explained in FIG. 14 is changed and is stored in advance as a reference example and the drive condition at that time is also stored as a reference drive condition. For example, a value C100, at which the electrostatic capacitance becomes constant on the high voltage side, a value C0, at which the electrostatic capacitance becomes constant at the low voltage side, etc., are stored. Further, values at which the electrostatic capacitance is in the middle, for example, the evolution voltages, etc., when the values are 25%, 50%, 90%, etc., of the C100 between the C100 and C0 are also stored.

P represents the change in capacitance with respect to the evolution voltage of the display element of target of adjustment of the drive condition. In the change in capacitance P, C100 and C0 are increased to C100′ and C0′ compared to the reference example R, the slope in the middle part is increased, and the electrostatic capacitance values, such as 25%, 50%, 90%, etc., of C100 between C100 and C0, the evolution voltages at that time, etc., are also increased.

In the drive condition adjustment method of the first embodiment, C100′ and C0′ are detected in the first stage.

In the second stage, the evolution voltage is determined so that a predetermined electrostatic capacitance value (for example, 25%, 50%, 90%, etc.) between C100′ and C0′ may be obtained by changing the duty ratio of the selection pulse. In other words, the evolution voltage is determined so that the contrast and brightness close to the maximum may be obtained.

As described above, in the first embodiment, the evolution voltage is changed, however, it is not possible to change C100′ and C0′ only by changing the evolution voltage. As illustrated in FIG. 14, if the evolution voltage is increased too high, there is a case where, for example, even when the duty ratio of the selection pulse is equal to or less than 50%, the electrostatic capacitance is C0′, and therefore, it is not possible to produce a halftone display. If the evolution voltage is further increased, there is a case where even when the duty ratio of the selection pulse is close to 0%, the electrostatic capacitance is C0′, and therefore, it is not possible to produce a display itself.

Consequently, in the first embodiment, the evolution voltage is set by causing C100′ and C0′ to correspond to luminance 0 and 100 (relative value) of the display so that the halftone part changes in accordance with the change in the duty ratio of the selection pulse.

In the third stage, the change in the duty ratio of the selection pulse is determined so that the change in the halftone part is linear.

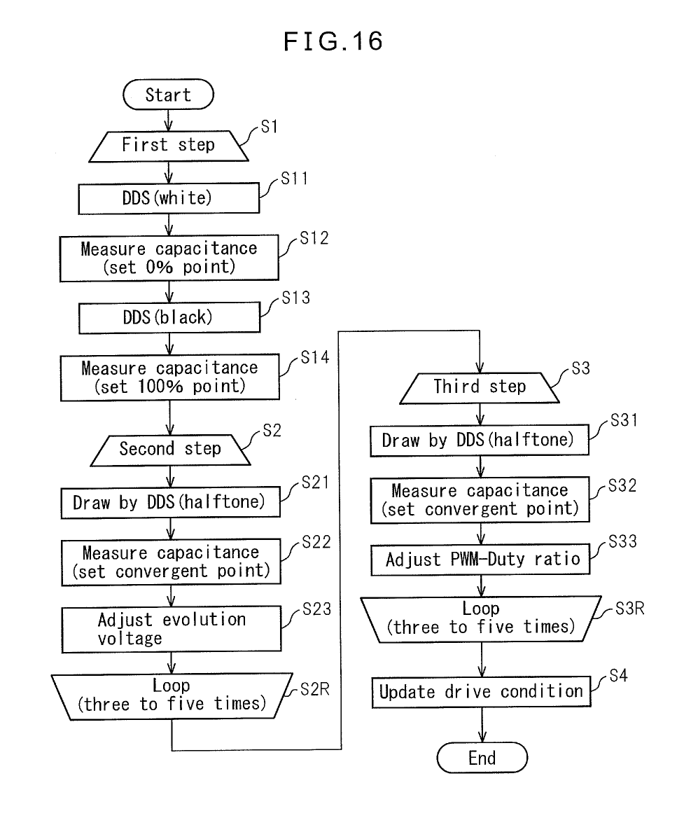

FIG. 16 is a flowchart illustrating automatic adjustment processing of drive condition in the display device of the first embodiment. The processing includes first step S1, second step S2, third step S3, and final step S4. In first step S1, C0′ and C100′ described above are detected and caused to correspond to luminance 0 and 100 (relative value). In second step S2, the evolution voltage is set so that a predetermined electrostatic capacitance value of the halftone part determined from C0′ and C100′ may be obtained. In third step S3, a relationship between the electrostatic capacitance value of the halftone part and the duty ratio of the selection pulse is set at the determined evolution voltage. In final step S4, the drive condition is updated in accordance with the determined evolution voltage and the duty ratio of the selection pulse.

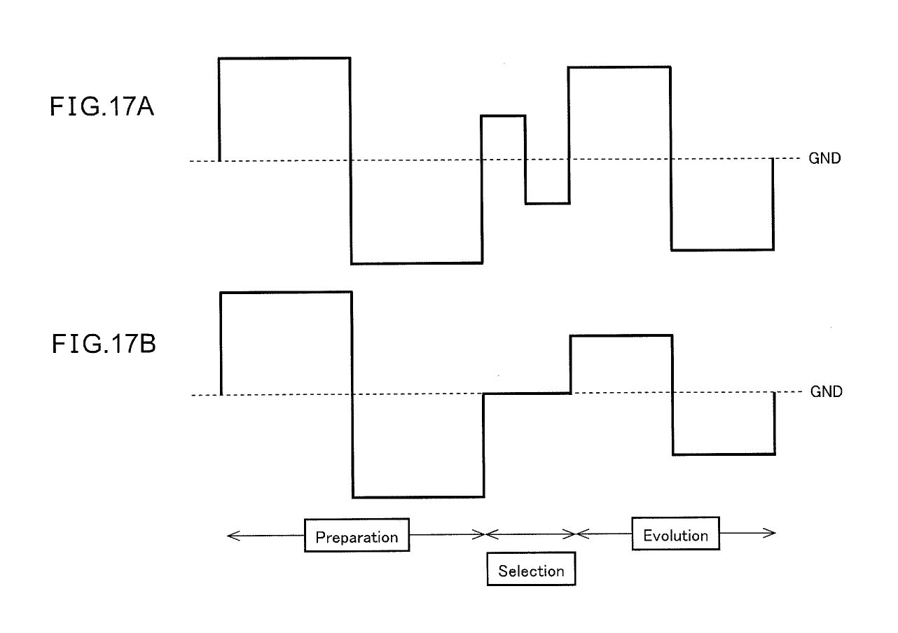

In step S11 of first step S1, drawing to bring all the pixels of the display element 10 into the white display state (planar state) by the DDS system is performed. In step S11, in order to bring all the pixels into the white display state without fail, the duty ratio of the selection pulse is set to 100% and further, the evolution voltage is set somewhat higher than usual as illustrated in FIG. 17A.

In step S12, the electrostatic capacitance of the display element 10 in the white display state set in step S11 is measured and the value is set as a 0% point. Consequently, C0′ corresponds to the 0% point.

In step S13, drawing to bring all the pixels of the display element 10 into the black display state (focal conic state) by the DDS system is performed. In step S13, in order to bring all the pixels into the black display state without fail, the duty ratio of the selection pulse is set to 0% (no selection pulse) as illustrated in FIG. 17B and further, the evolution voltage is set somewhat lower than usual.

In step S14, the electrostatic capacitance of the display element 10 in the black display state set in step S11 is measured and the value is set as a 100% point. Consequently, C100′ corresponds to the 100% point.

Second step S2 includes steps S21 to S23 and as illustrated in step 2R, these steps S21 to S23 are repeated three to five times.

In step S21, drawing to bring all the pixels of the display element 10 into the halftone display state (planar state+focal conic state) is performed. The halftone to be set may be any gradation, such as 90%, 50%, and 25%. For example, when 25% is set, under the drive condition stored in advance, all of the pixels of the display element 10 are brought into the halftone display state by the DDS system with the duty ratio of the selection pulse set to 25%. When the halftone to be set is 90%, the evolution voltage is set so that the display contrast close to the maximum is obtained, and therefore, this is preferable from the viewpoint of the display contrast.

In step S22, the electrostatic capacitance of the display element 10 in the halftone display state set in step S21 is measured.

In step S23, a target electrostatic capacitance value corresponding to the halftone to be set is calculated from the electrostatic capacitances C0′ and C100′ corresponding to the 0% point and the 100% point determined in steps S12 and S14 and the electrostatic capacitance value measured in step S22 is compared with the target electrostatic capacitance value. Then, based on the comparison result, the evolution voltage is adjusted so that the measured electrostatic capacitance value agrees with the target electrostatic capacitance value.

When the measured electrostatic capacitance value obtained in step S22 becomes close to the target electrostatic capacitance value by repeating steps S21 to S23, step S2 is exited and step S3 is entered.

As the method for adjusting the evolution voltage, any method may be used as long as adjustment is made so that the measured electrostatic capacitance value agrees with the target electrostatic capacitance value. Such a method is known as the root calculating algorithm and typical methods include the Newton's method and dichotomy. An example in which these methods are applied is explained.

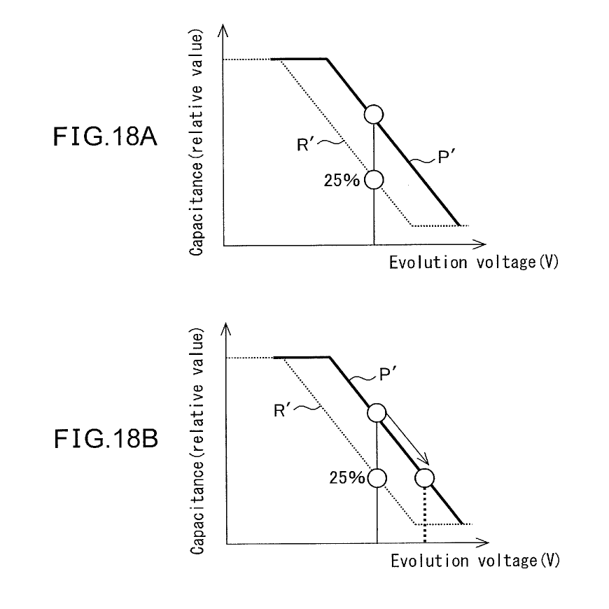

FIG. 18A and FIG. 18B are diagrams explaining the method for adjusting the evolution voltage so that the measured electrostatic capacitance value agrees with the target electrostatic capacitance value by the Newton's method, an example in which the halftone to be set is 25%.

In the Newton's method, the standard capacitance change characteristics with respect to the evolution voltage as illustrated in FIG. 14 and FIG. 15A are stored in advance. As the characteristics, it is sufficient to simply store the slope and intercept of a linear function. In FIG. 18A and FIG. 18B, R′ represents the standard capacitance change characteristics and P′ represents the capacitance change characteristics of target of adjustment.

As illustrated in FIG. 18A, the standard 25% evolution voltage with which the electrostatic capacitance value changes from C0′ to 25% (the interval between C0′ and C100′ is taken to be 100%) is found from the stored standard capacitance change characteristics R′ and at the standard 25% evolution voltage, all the pixels are brought into the halftone display state by the DDS system with the duty ratio set to 25%. It is assumed that the measurement result of the electrostatic capacitance in this state is C0′ to 50%.

As illustrated in FIG. 18B, from the stored slope, the amount of change in the evolution voltage that changes the electrostatic capacitance from 50% to 25% is found and then the standard 25% evolution voltage is changed by the amount of change. Then, when the same processing is performed again with the changed evolution voltage, the measured electrostatic capacitance becomes closer to the value 25% from C0′. If such processing is repeated several times, it is possible to determine the evolution voltage that brings about the state where the electrostatic capacitance becomes closer to the value 25% from C0′. The electrostatic capacitance that changes from C0′ to 25% is explained as an example, however, the electrostatic capacitance may change from C0′ to 50% or 90% as described previously.

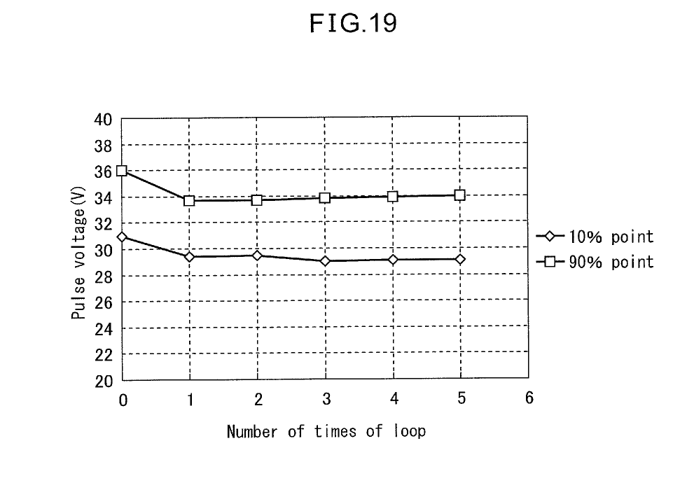

FIG. 19 illustrates the changes in the evolution voltage when the Newton's method is performed on the electrostatic capacitances that change from C0′ to 10% and 90%. It is known that the value converges to substantially a constant value if the Newton's method is performed two to three times.

It is known that the Newton's method has such a problem that divergence occurs instead of convergence if the target to be solved has characteristics that change too steeply or change concavely and convexly. However, the evolution voltage-electrostatic capacitance characteristics when adjusting the evolution voltage are those which change very monotonically with respect to the evolution voltage, and therefore, it is possible to cause convergence to occur substantially without fail by applying the Newton's method.

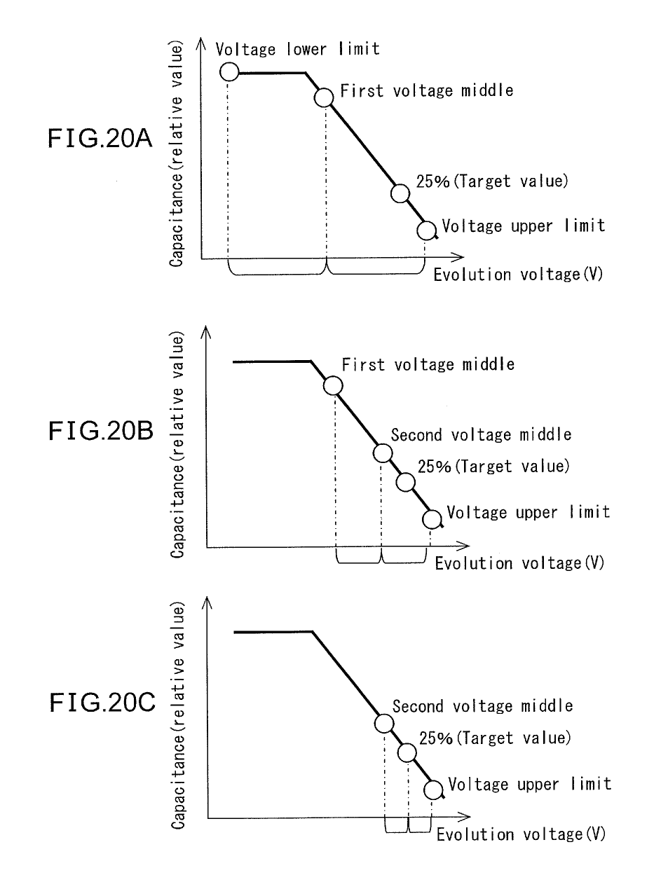

FIG. 20A to FIG. 20C are diagrams for explaining the method for adjusting the evolution voltage by the dichotomy so that the measured electrostatic capacitance value agrees with the target electrostatic capacitance value, an example of a case where the halftone to be set is 25%.

In the dichotomy, the standard capacitance change characteristics with respect to the evolution voltage is not stored in advance.

As illustrated in FIG. 20A, a first voltage middle is set in the middle between the voltage upper limit and the voltage lower limit of the variable range of the evolution voltage. Then, the evolution voltage is taken to be the first voltage middle and the duty ratio to be 25%, and all the pixels of the display element 10 are brought into the halftone display state by the DDS system. It is assumed that the electrostatic capacitance measured in this state is an electrostatic capacitance value larger than that from C0′ to 25%. In this case, it is determined that the first voltage middle is small and needs to be increased.

As illustrated in FIG. 20B, a second voltage middle is set in the middle between the first voltage middle and the voltage upper limit. Then, the evolution voltage is taken to be the second voltage middle and the duty ratio to be 25%, and all the pixels of the display element 10 are brought into the halftone display state by the DDS system. It is assumed that the electrostatic capacitance measured in this state is still an electrostatic capacitance value larger than that from C0′ to 25%. In this case, it is determined that the second voltage middle is low and needs to be increased.

As illustrated in FIG. 20C, a third voltage middle is set in the middle between the second voltage middle and the voltage upper limit. Then, the evolution voltage is taken to be the third voltage middle and the duty ratio to be 25%, and all the pixels of the display element 10 are brought into the halftone display state by the DDS system. It is assumed that the electrostatic capacitance measured in this state is an electrostatic capacitance value from C0′ to 25%, then the third voltage middle proves to be the appropriate evolution voltage.

In general, the dichotomy is characterized in that divergence is hard to occur but convergence takes time compared to the Newton's method. However, the evolution voltage-electrostatic capacitance characteristics are characteristics that change very monotonically with respect to the evolution voltage, and therefore, by repeating five steps, convergence to substantially a constant value is achieved.

Returning to FIG. 16, in third step S3, by using the evolution voltage determined in step S2, a relationship between the electrostatic capacitance value of the halftone part and the duty ratio of the selection pulse is set.

In step S31, all of the pixels of the display element 10 are brought into the target halftone display state where any of halftones to be displayed is displayed. This processing is the same as that in step S21.

In step S32, the electrostatic capacitance of the display element 10 in the target halftone display state set in step S31 is measured.

In step S33, a target electrostatic capacitance value corresponding to the target halftone display state is calculated and the measured electrostatic capacitance value in step S32 is compared with the target electrostatic capacitance value. Then, the duty ratio of the selection pulse is determined based on the comparison result so that the measured electrostatic capacitance value agrees with the target electrostatic capacitance value.

When the measured electrostatic capacitance value obtained in step S32 becomes close to the target electrostatic capacitance value by repeating steps S31 to S33, step S3 is exited.

In the case of the DDS drive system, the response of liquid crystal is considerably steep, and therefore, it is difficult to form a halftone. As a result, the halftones that may be displayed is about three to seven gradations. By repeating third step as to each of these halftones and the duty ratio of the selection pulse as to all the halftones to be displayed is determined, then, the next step is step S4.

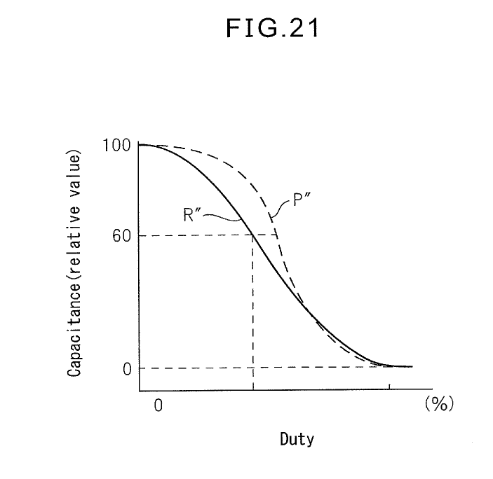

FIG. 21 is a diagram for explaining adjustment in third step S3 and illustrates the change in the electrostatic capacitance with respect to the duty ratio of the selection pulse. In FIG. 21, R″ represents the standard duty ratio capacitance change characteristics and P″ represents the duty ratio capacitance change characteristics of target of adjustment. This example corresponds to the case where the evolution voltage is determined after a halftone of 25% is set in second step S2. In this case, if the duty ratio of the selection pulse is set to 25% and drive is performed with the evolution voltage determined in step S2 by the DDS system, a desired electrostatic capacitance value, i.e., a halftone is obtained. However, in FIG. 21, the slope of the characteristics of the display element of target of adjustment is steep compared to the supposed characteristics R″, and therefore, even if drive is performed with the supposed duty ratio of the selection pulse, the supposed electrostatic capacitance value (halftone) is not obtained. For example, according to the supposed characteristics R″, the electrostatic capacitance value at the 60% point (halftone) is obtained if the duty ratio is set to 40%, however, the duty ratio is set to 50% for the characteristics P″ of the display element of target of adjustment.

A duty ratio of the selection pulse with which such an electrostatic capacitance (halftone) is obtained is determined for the electrostatic capacitance of the halftone part and the drive condition is updated to the duty ratio of the selection pulse determined in this manner. By applying the Newton's method or dichotomy to each of the electrostatic capacitances of the halftone part, the duty ratio of the selection pulse is determined. In the case of the DDS drive system, the response of liquid crystal is considerably steep, and therefore, it is difficult to form a halftone. Therefore, when determining the duty ratio of the selection pulse, the Newton's method may be used, however, it is possible for the dichotomy the risk of divergence of which is lower to find an optimum value more appropriately.

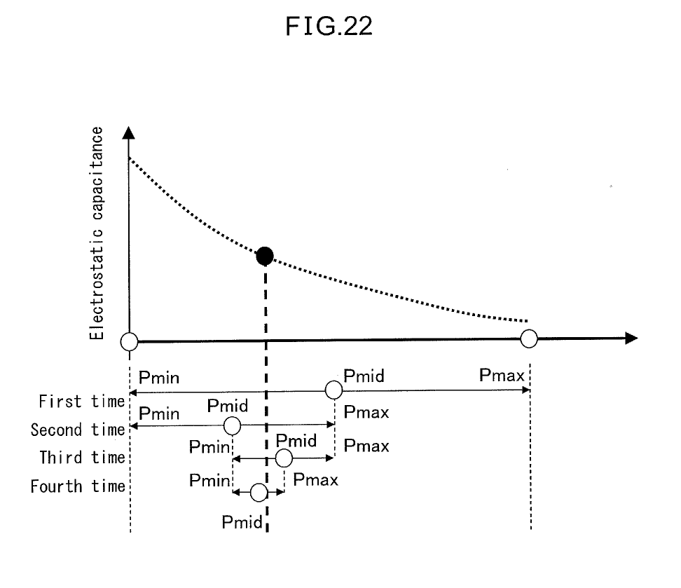

FIG. 22 is a diagram for explaining processing when third step S3 is performed using the dichotomy. In the dichotomy, an upper limit Pmax and a lower limit Pmin of a PWM-Duty ratio in a search range are set. In first search processing, the PWM-Duty ratio is set to a middle value Pmid=(Pmax+Pmin)/2 between Pmax and Pmin and a halftone display is produced, and then, the electrostatic capacitance at that time is measured. When it is determined that a difference between the measured electrostatic capacitance value and the target electrostatic capacitance value is larger than a threshold value, second search processing is performed. As illustrated schematically, when the measured electrostatic capacitance value is smaller than the target electrostatic capacitance value, Pmid is taken to be Pmax, the PWM-Duty ratio is set to the middle value Pmid=(Pmax+3Pmin)/4 between Pmin and Pmax, and a halftone display is produced, and then, the electrostatic capacitance value at that time is measured. When it is determined that a difference between the measured electrostatic capacitance value and the target electrostatic capacitance value is larger than the threshold value, third search processing is performed. As illustrated schematically, when the measured electrostatic capacitance is larger than the target electrostatic capacitance value, Pmid is taken to be new Pmin, the PWM-Duty ratio is set to the middle value Pmid=(3Pmax+5Pmax)/8, and a halftone display is produced, and then, the electrostatic capacitance value at that time is measured. When it is determined that a difference between the measured electrostatic capacitance value and the target electrostatic capacitance value is larger than the threshold value, fourth search processing is performed. As illustrated schematically, when the measured electrostatic capacitance is smaller than the target electrostatic capacitance value, Pmid is taken to be new Pmax, the PWM-Duty ratio is set to the middle value Pmid=(5Pmax+11Pmax)/8, and a halftone display is produced, and then, the electrostatic capacitance value at that time is measured. When a difference between the measured electrostatic capacitance value and the target electrostatic capacitance value is equal to or less than the threshold value, the search processing is stopped and the PWM-Duty ratio is taken to be Pmid=(5Pmax+11Pmin)/8.

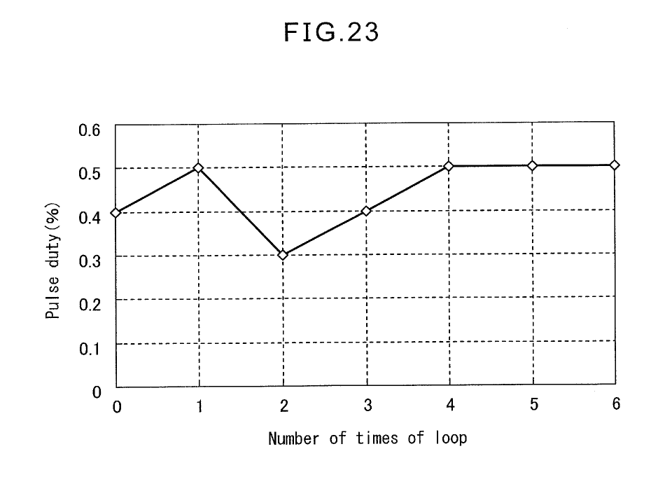

FIG. 23 illustrates a change in duty ratio when the dichotomy is performed to determine a duty ratio to obtain the electrostatic capacitance of the 60% point. It may be seen that convergence to substantially a constant value is achieved by repeating the dichotomy five or more times.

In the manner described above, in the display device of the first embodiment, it is possible to produce an excellent display at all times by automatically optimizing the drive condition even if the characteristics of the display element 10 vary due to variations between lots and the secular change.

By performing the drive condition automatic adjustment processing as described above, the display is optimized, however, this processing requires a long processing time and may require several minutes to complete the adjustment in some cases. In particular, it is possible for the dichotomy to find an optimum value more favorably than the Newton's method, however, its convergence takes time. Therefore, a reduction in time for the drive condition automatic adjustment processing is demanded.

In the search algorithm of the optimum drive condition explained in FIG. 16 to FIG. 23, the search range and the number of times of loop are fixed, and therefore, a certain adjustment time is provided after a command to start automatic adjustment is given regardless of the magnitude of the deviation of the drive condition.

Consequently, in the first embodiment, a search algorithm below is used, which is a search algorithm of the optimum drive condition caused to have flexibility and configured to further reduce the adjustment time while maintaining high adjustment precision. In this search algorithm, the first drive condition automatic adjustment processing is performed as described above, however, in the second and subsequent drive condition automatic adjustment processing, the degree of deviation of the drive condition is detected and the algorithm is simplified in accordance with the degree of deviation, and thus, the processing time is reduced.

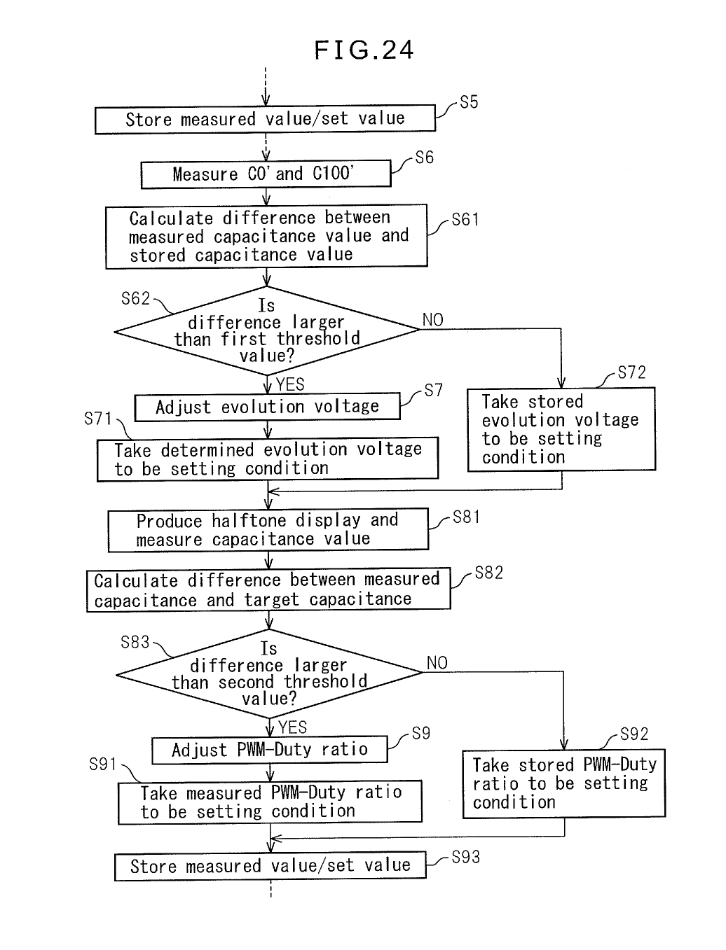

FIG. 24 is a flowchart illustrating the drive condition automatic adjustment processing that makes use of this search algorithm.

As described above, the drive condition automatic adjustment processing illustrated in FIG. 16 is performed once in advance, the electrostatic capacitances corresponding to the white display and the black display are measured, and the evolution voltage and the duty ratio of the selection pulse to obtain the target electrostatic capacitance value are already determined.

In step S5, the control unit 23 stores the electrostatic capacitances (C0′ and C100′) measured in the previous drive condition automatic adjustment processing and the evolution voltage and the duty ratio of the selection pulse that are set in a memory, not illustrated schematically.

After step S5, the drive condition automatic adjustment processing is started again for maintenance etc.

First, step S6 is performed. In step S6, the same processing as that in first step S1 including S11 to S14 in FIG. 16 is performed. Due to this, the electrostatic capacitance values C0′ and C100′ corresponding to the 0% point and the 100% point are measured.

In step S61, a difference D0 between the electrostatic capacitance value C0′ measured in S6 and the previous electrostatic capacitance value stored in S0 and a difference D100 between C100′ measured in S6 and the previous electrostatic capacitance value stored in S0 are calculated, respectively. D0 is the absolute value of the difference between the electrostatic capacitance value C0′ measured in S6 and C0′ stored in S5 and D100 is the absolute value of the difference between the electrostatic capacitance value C100′ measured in S6 and C100′ stored in S5.

In step S62, whether the difference is larger than a first threshold value is determined and when the determination result is affirmative, the procedure proceeds to step S7 and when negative, to step S72. As described above, the differences are D0 and D100, i.e., two, and therefore, the two first threshold values are set accordingly. It is assumed that when at least one of the differences D0 and D100 is larger than the first threshold value, the procedure proceeds to S7, however, it may also be possible to set so that only when both are larger than the first threshold values, the procedure proceeds to S7. When the procedure proceeds to S72, the adjustment of the evolution voltage is not performed but skipped.

As will be described later, the processing performed in step S7 is the voltage adjustment during the evolution period during which the contrast of a display is determined. The evolution voltage has a comparatively large margin and the voltage range to obtain a constant contrast is between 2 V and 3 V, although depending on the material and structure configuring the panel. Therefore, it is possible to set the first threshold value comparatively large, i.e., to make the condition to skip comparatively less stringent. For example, it may be possible to set the first threshold values of the differences D0 and D100 to 5% of C0′ and C100′, respectively. Consequently, the change of C0′ or C100′ measured in S6 is a change of 5% or less from C0′ or C100′ stored in S5, the procedure proceeds to step S72 and the adjustment processing of the evolution voltage is skipped. Conversely, when C0′ or C100′ measured in S6 changes by more than 5% from C0′ or C100′ stored in S5, the procedure proceeds to step S7.

In step S7, the same processing as that in second step S2 including S21 to S2R in FIG. 16 is performed. By this, the evolution voltage is determined.

In step S71, the evolution voltage determined in S7 is taken to be the setting condition.

In step S72, the evolution voltage stored in S5 is taken to be the setting condition.

In step S81, the processing in steps S31 and S32 in FIG. 6 is performed with the set evolution voltage and the electrostatic capacitance value when a predetermined halftone display is produced is measured. The predetermined halftone display is produced with the PWM-Duty ratio at the time of the previous processing stored in S5 by using the set evolution voltage.

In step S82, a difference between the electrostatic capacitance value measured in S81 and the electrostatic capacitance value of the halftone stored in S5 is calculated.

In step S83, whether the difference calculated in S82 is larger than a second threshold value is determined and when the determination result is affirmative, the procedure proceeds to step S9 and when negative, to step S92,

In step S9, the adjustment of the PWM-Duty ratio is performed. This adjustment processing is processing similar to that in step S3 including S31 to S3R in FIG. 16, however, differs in that the processing is exited when the difference between the measured electrostatic capacitance value and the target electrostatic capacitance value is equal to or less than the second threshold value and in that the calculation method of the middle value is different. This processing will be described later.

In step S91, the PWM-Duty ratio determined in S9 is taken to be the setting condition.

In step S92, the PWM-Duty ratio stored in S5 is taken to be the setting condition.

In step S93, the electrostatic capacitance value and the drive condition are stored. Specifically, the electrostatic capacitance values C0′ and C100′ measured in S6, the evolution voltage set in S71 or S72, and the PWM-Duty ratio set in S91 or S92 are stored. For example, when the evolution voltage is set in S71, the evolution voltage set in S7 is stored and when the evolution voltage is set in S72, the evolution voltage determined in the previous adjustment processing stored in S5 is stored. Further, when the PWM-Duty ratio is set in S91, the PWM-Duty ratio determined in S9 is stored and when the PWM-Duty ratio is set in S92, the PWM-Duty ratio determined in the previous processing stored in S5 is stored.

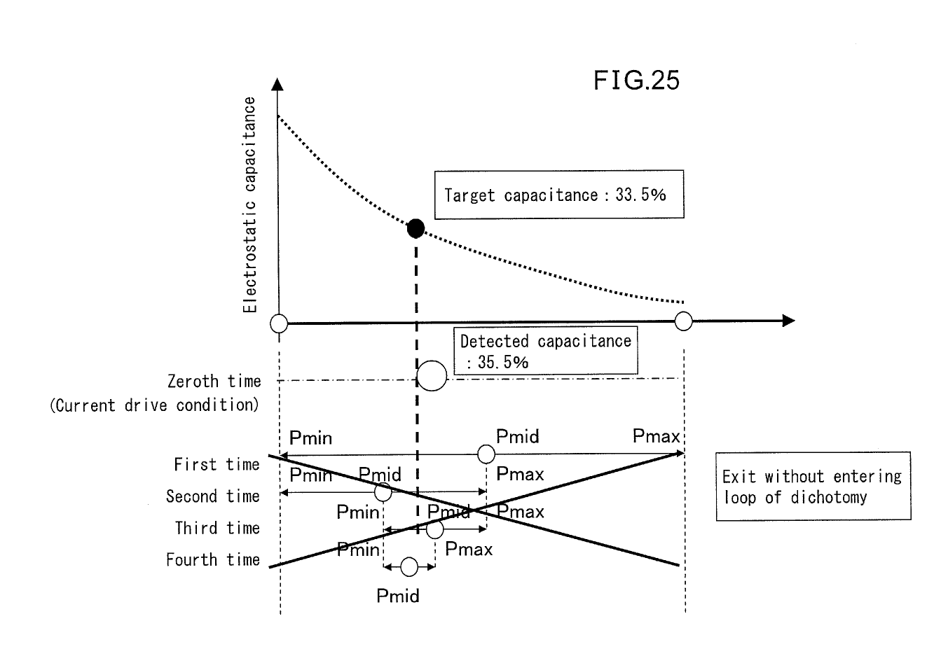

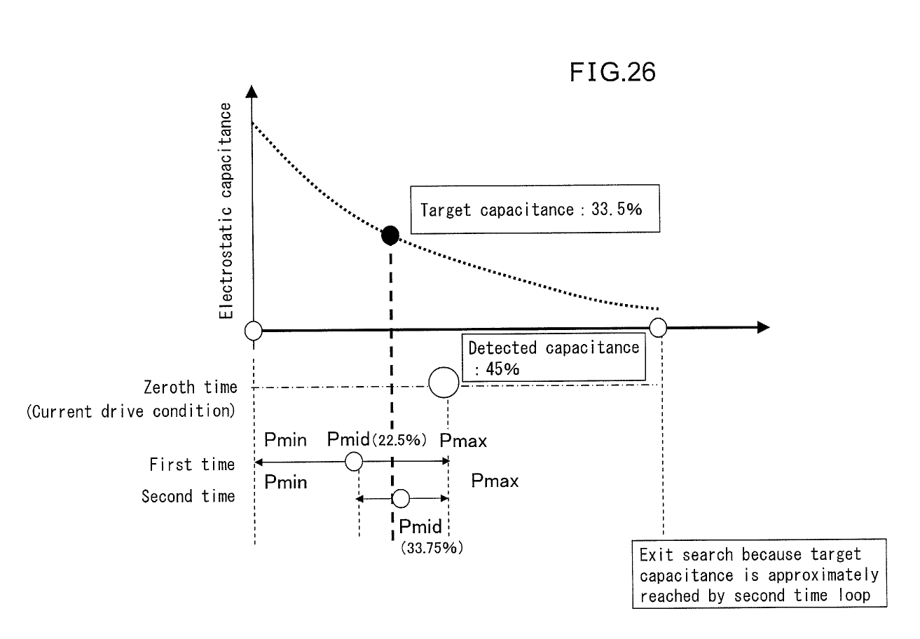

Next, a case where the processing in S83 to S92 is performed by using the dichotomy is explained in detail with reference to FIG. 25 and FIG. 26. It is assumed that the three RGB layers of the panel 10 produce a display with 16 gradations, respectively.

FIG. 25 illustrates processing when the difference calculated in S82 is determined to be equal to or less than the second threshold value in step S83. As described previously, in step S81, a halftone display is produced by using the set evolution voltage and with the PWM-Duty ratio at the time of the previous processing stored in S5, and then, the electrostatic capacitance value is measured. In FIG. 25, Pmax is taken to be 100% and Pmin to be 0% and when a halftone display is produced with the stored PWM-Duty ratio of 35%, the measured electrostatic capacitance value is 35.5%. The target capacitance is 33.5%, and therefore, the difference is 2%, and is smaller than the second threshold value, and therefore, the procedure proceeds from step S83 to step S92 and step S9 is not performed. In other words, the search of the PWM-Duty ratio by the dichotomy is not performed.

Whether or not to skip the second threshold value, i.e., the search of the PWM-Duty ratio by the dichotomy, is determined on the premise that predetermined 16 gradations may be formed. For example, when the range of 0 to 100% of the electrostatic capacitance is divided into 16 gradations, the width of the electrostatic capacitance of each gradation is 100/(16−1)=6.7%, and therefore, it is ideal to divide the range into 16 gradations in steps of 6.7%. Consequently, it is desirable for the second threshold value to be 3.3% or less. If an N-gradation display is produced, it is desirable to set the difference between the measured electrostatic capacitance and the target electrostatic capacitance to ±100/2(N−1) or less as a result.

FIG. 26 illustrates an example of the processing in step S9. It is assumed that the measured electrostatic capacitance value is 45%, which is measured by producing a halftone display with the PWM-Duty ratio at the time of the previous processing stored in S5 by using the set evolution voltage in step S81. In this case also, the target electrostatic capacitance value is 33.5% and the difference is 11.5%, and therefore, the difference is determine to be equal to or more than the second threshold value in step S83 and step S9 is performed.

In step S9, different from third step S3 of FIG. 16, by setting a middle value between the measured electrostatic capacitance value measured by producing a halftone display and Pmax or Pmin, the search range is narrowed from the first to aim at a reduction in search time. As illustrated in FIG. 26, the measured electrostatic capacitance value 45% measured in step S81 is larger than the target electrostatic capacitance value 33.5%, and therefore, the first search is performed by taking Pmax to be the measured electrostatic capacitance value 45% and setting the PWM-Duty ratio to the middle value Pmid (22.5%) between the Pmin (0%) and Pmax (45%). The dichotomy is started with Pmax and Pmin of the search range being set to 45% and 0%, and therefore, it is possible to satisfy the specified value of the error of the electrostatic capacitance value by only two times of loop and to complete the search as illustrated in FIG. 26.

The search algorithm capable of reducing time is not limited to the example described above and there may also be various kinds of modified examples. Further, it is also possible to apply the search algorithm to narrow the search range from the first by making use of the measured electrostatic capacitance value and other modified examples to the search of the evolution voltage.

In the display device of the first embodiment, when the electrostatic capacitance of the display element 10 is detected, the display element 10 is driven by the DDS drive system and all the pixels are brought into the same display state. When driving the display element 10 by the DDS drive system, a drive waveform as illustrated in FIG. 8 is applied to all the scan lines while shifting the application position, and therefore, it takes a certain period of time. Therefore, it is desirable to perform step S31 of FIG. 16 for all the halftones to be displayed and in the case of the eight-gradation display, the display state is set about five times for the seven kinds of halftones, and therefore, the setting of the display screen takes a long time.

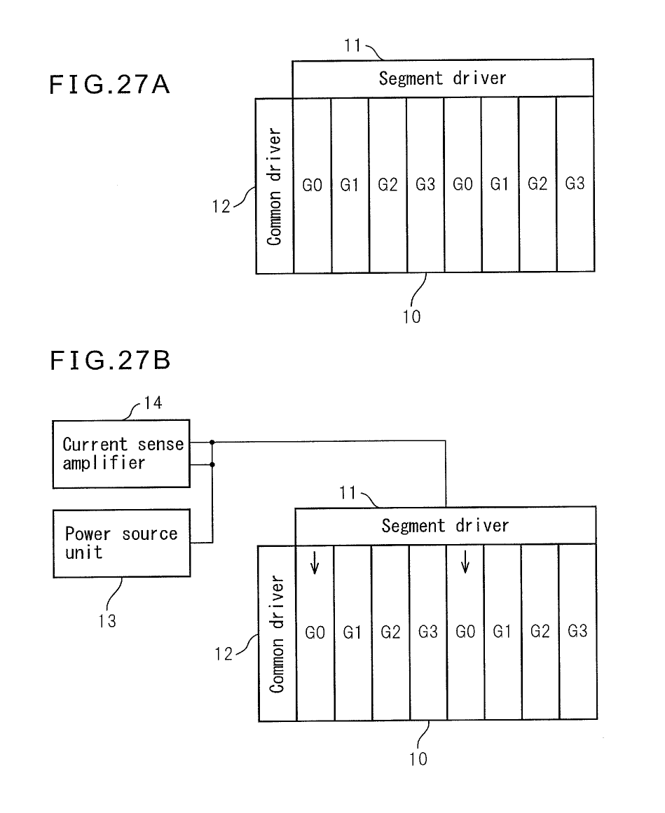

Because of the above, the display screen of the display element 10 is divided into a plurality of regions (eight regions in FIG. 27A) in correspondence to the terminals of the segment driver 11 and the regions with different gradation levels are displayed on the display screen at the same time. In FIG. 27A, two regions are brought into the state for displaying the same gradation and four kinds of gradations G0 to G3 are displayed. Then, as illustrated in FIG. 27B, when measuring the electrostatic capacitance in the state for displaying the gradation G0, the segment driver 11 controls to apply an electrostatic capacitance detection signal only to the regions displaying the gradation G. In this manner, as to the gradations G1 to G3, the measurement of the electrostatic capacitance is performed in the same manner. Therefore, it is possible to reduce the time to change the display state of the display element 10 to about ¼ of that of the first embodiment.

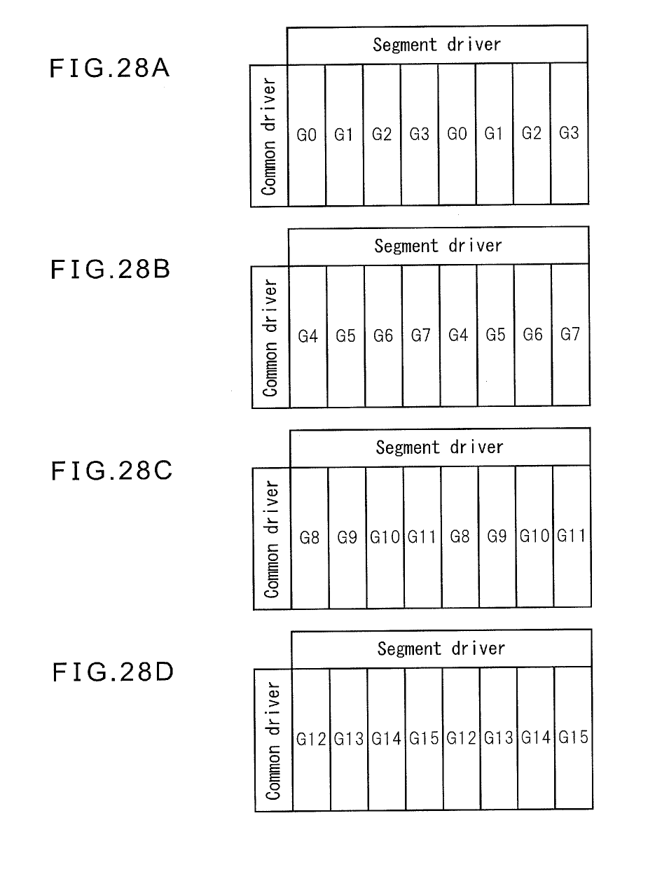

FIG. 28A to FIG. 28D are diagrams illustrating an example of the display screen when measuring the electrostatic capacitance of the 16 kinds of gradations G0 to G15. In the first time, four kinds of gradations G0 to G3 are displayed and third step S3 of FIG. 16 is repeated five times. In the second time, four kinds of gradations G4 to G7 are displayed and third step S3 of FIG. 16 is repeated five times. In this manner, the same operation is performed for the gradations G8 to G11 and G12 to G15.

The reason two regions are provided to display the same gradation within the screen in FIG. 27A to FIG. 28D is to remove the influence of the screen variations.

In addition to the above, as an effective method for reducing the time for calibration of multiple gradations, there is a method in which only the duty ratio of one or two halftones is determined by the search algorithm and the duty ratios of other halftones are determined by using interpolation processing, such as extrapolation and interpolation, based on the duty ratio determined by the search algorithm.

In the display device of the first embodiment, in first step S1, the electrostatic capacitances caused to correspond to luminance 0 and 100 (relative values) are determined and in second step S2, the evolution voltage is set so that the predetermined electrostatic capacitance value of the predetermined halftone part is obtained from the electrostatic capacitance determined in first step S1. Then, in third step S3, the relationship between the electrostatic capacitance value of the halftone part and the duty ratio of the selection pulse is set using the evolution voltage determined in second step S2. If the variations in the luminance 0 and 100 (relative values) and in the electrostatic capacitance caused to correspond thereto are small because of the characteristics of the display element, first step S1 may be omitted. In this case also, when there are such variations that shift the electrostatic capacitance change characteristics with respect to the evolution voltage of FIG. 14 in the transverse direction, steps S2 and S3 are performed. If such variations that shift the electrostatic capacitance change characteristics with respect to the evolution voltage of FIG. 14 in the transverse direction are small, it is sufficient to perform only step S3 by further omitting step S2.

On the contrary, when the variations in the change of the electrostatic capacitance value (halftone) with respect to the duty ratio of the selection pulse illustrated in FIG. 21 are small, it is possible to omit third step S3.

Further, in the display device of the first embodiment, it is made possible to obtain desired display characteristics by adjusting the evolution voltage and the duty ratio of the selection pulse. However, as described previously, there are other factors of the drive condition that change the display characteristics and when adjusting the other factors, it is also possible to apply the above-mentioned method for adjusting the drive condition based on the detected electrostatic capacitance by detecting the electrostatic capacitance of the display element in a different state.

Furthermore, in the display device of the first embodiment, the unipolar driver IC is used, however, it is also possible to use a bipolar driver IC.

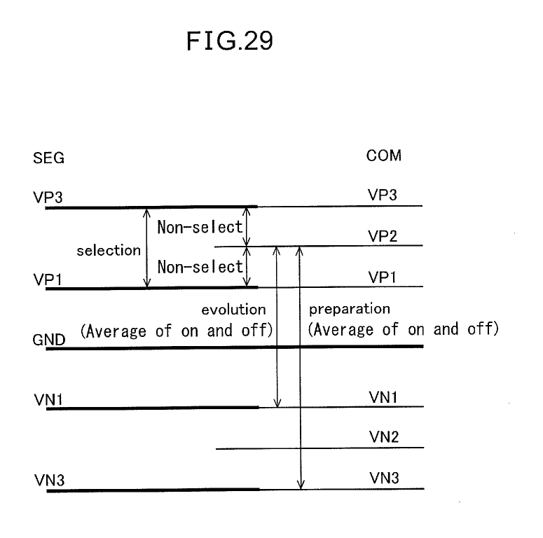

FIG. 29 is a diagram illustrating a correspondence relationship of the output voltages of the segment driver 11 and the common driver 12 when using a bipolar driver IC.

Voltages are defined as VP3, VP2, VP1, 0, VN1, VN2, and VN3 in the descending order from the highest voltage from the +side toward the −side. At the time of the positive polarity phase, when the white display is drawn, a difference voltage between SEG-VP3 and COM-VP1 is applied during the selection period and when the black display is drawn, a difference voltage between SEG-VP1 and COM-VP1 is applied during the selection period. During the preparation period and during the evolution period, an average voltage is applied respectively in the relationship of FIG. 29. At the time of the negative polarity phase, the correspondence relationship between VP and VN described above is reversed.

Calculation equations to develop from the evolution voltage to each of VP3, VP2, VP1, 0, VN1, VN2, and VN3 on the SEG side and on the COM side are illustrated below. The non-select voltage is a voltage applied to all the pixels already drawn or not drawn yet during period other than the preparation, selection, and evolution periods.

SEG_{—}VP3=((evolution voltage)+3*non-select voltage)/2

SEG_{—}VP2=(((evolution voltage)+3*non-select voltage)−non-select voltage)−SEG_{—}VP3

SEG_{—}VP1=SEG_{—}VP3−non-select voltage*2

SEG_{—}VN3=−(SEG_{—}VP3)

SEG_{—}VN2=−(SEG_{—}VP2)

SEG_{—}VN1=−(SEG_{—}VP1)

COM_{—}VP3=SEG_{—}VP3

COM_{—}VP2=SEG_{—}VP2

COM_{—}VP1=SEG_{—}VP1

COM_{—}VN3=−(COM_{—}VP3)

COM_{—}VN2=−(COM_{—}VP2)

COM_{—}VN1=−(COM_{—}VP1)

In the manner described above, it is possible to produce an appropriate display by actually measuring the electrostatic capacitance of the display element 10 and by adjusting the drive condition to that which is in accordance with the detected electrostatic capacitance. However, such a drive condition may be used only for the temperature at which the actual measurement of the electrostatic capacitance and the adjustment of the drive condition are performed and when the temperature changes, the drive condition also changes, and therefore, the actual measurement of the electrostatic capacitance and the adjustment of the drive condition are performed again.

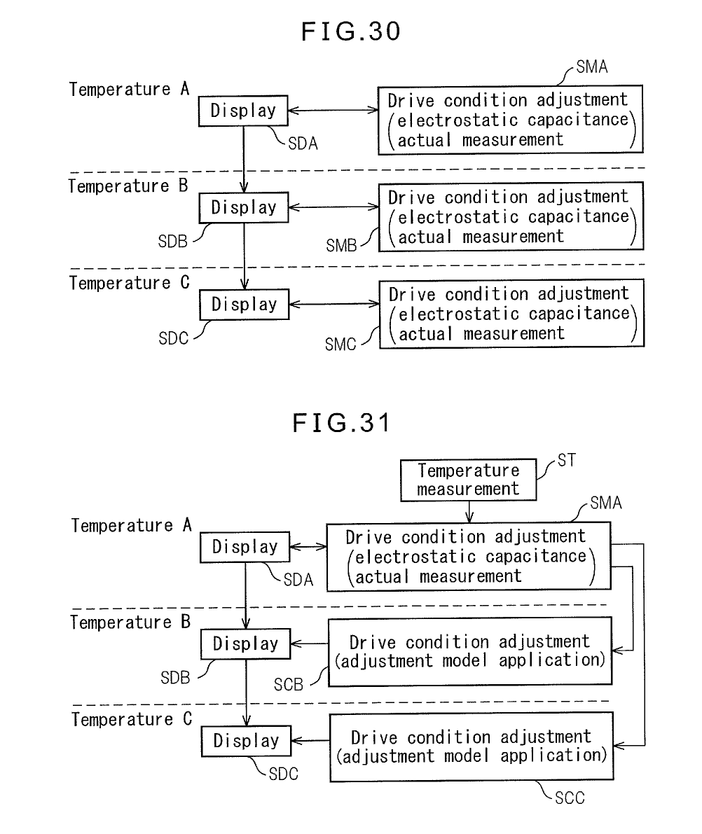

FIG. 30 is a diagram illustrating the operation at the time of rewrite of the display when the temperature changes from that at the time of the previous rewrite of the display. When the temperature is A, after performing an operation SMA of the actual measurement of the electrostatic capacitance and adjustment of the drive condition, a display SDA is produced. When producing a display when the temperature changes from A to B, after performing again an operation SMB of the actual measurement of the electrostatic capacitance and adjustment of the drive condition, a display SDB is produced. Further, when producing a display when the temperature changes from B to C, after performing again an operation SMC of the actual measurement of the electrostatic capacitance and adjustment of the drive condition, a display SDC is produced. The operation when adjusting the drive condition by measuring the electrostatic capacitance of the display element at all times using a dummy capacitance in a liquid crystal display device that displays a motion picture is an operation to adjust the drive condition in accordance with the electrostatic capacitance measured for each display, and therefore, the same as that of FIG. 30.

As describe previously, the operation of the actual measurement of the electrostatic capacitance and adjustment of the drive condition takes a long time, and therefore, if the operation is performed each time the temperature changes, there arises such a problem that the substantial responsiveness of the display element is reduced. Therefore, in the first embodiment, after or before performing the operation of the actual measurement of the electrostatic capacitance and adjustment of the drive condition described above, the temperature of the display element 10 is measured and the drive condition at the measured temperature is taken to be a new optimized condition and at the same time, the drive conditions at other temperatures are updated using the measured temperature and the temperature compensation model. That is, the drive conditions in the entire temperature range stored in the drive condition storage unit 26 are adjusted at the same time by one-time drive condition adjustment processing.

FIG. 31 is a diagram illustrating the drive condition adjustment processing in the first embodiment and the display rewrite operation when the temperature changes. When the temperature is A, the operation SMA of the actual measurement of the electrostatic capacitance and adjustment of the drive condition and temperature measurement ST are performed and the drive condition when the temperature is A is updated and further, the drive conditions at other temperatures are updated using the temperature A and the temperature compensation model. In other words, an operation SCB to adjust the drive condition at the temperature B and an operation SCC to adjust the drive condition at the temperature C are performed by making use of the adjusted drive condition at the temperature A and using the temperature A and the temperature compensation model. The display SDA at the temperature A is produced based on the updated drive condition. It may also be possible to update the drive conditions at other temperatures after producing the display SDA.

When rewriting the display the next time, the temperature of the display element 10 is measured and the drive condition corresponding to the measured temperature is read from the drive condition storage unit 26 and then the display rewrite operation is performed. For example, when performing the operation SDB to rewrite the display at the temperature B, the drive condition corresponding to the temperature B is read from the drive condition storage unit 26 and the display rewrite operation is performed in accordance with the read drive condition. Similarly, when performing the operation SDC to rewrite the display at the temperature C, the drive condition corresponding to the temperature C is read from the drive condition storage unit 26 and the display rewrite operation is performed in accordance with the read drive condition.

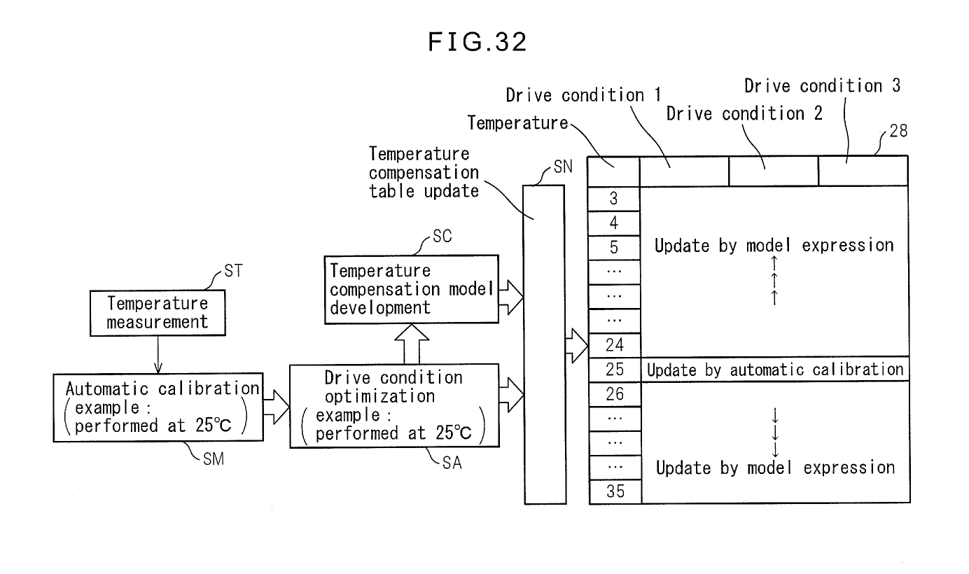

FIG. 32 is a diagram illustrating the drive condition adjustment processing operation in the first operation.

An automatic calibration SM to measure the electrostatic capacitance of the display device 10 and to measure the characteristics relating to the drive condition is performed. Before or after the automatic calibration SM, the temperature measurement ST of the display element 10 is performed. It is assumed that the automatic calibration SM is performed at, for example, 25° C. After the automatic calibration SM, processing SA to optimize the drive condition at 25° C. is performed. Further, temperature compensation model development SC to optimize the drive condition at each temperature in the entire temperature range using a temperature compensation model is performed by making use of the adjusted drive condition at 25° C. After that, a drive condition table 28 that stores the drive condition at each temperature across the entire temperature range stored in the drive condition storage unit 26 is updated by the drive conditions in the entire temperature range including the optimized drive condition at 25° C.

Next, the temperature compensation model is explained.

The characteristics of the display device change in accordance with the change in temperature and the drive condition changes in accordance therewith. The temperature compensation model is requested to be able to realize adjustment by which a favorable display may be produced in the entire temperature range accurately in accordance with the change in the drive condition in accordance with the change in temperature. It has been made clear that it is preferable for the temperature compensation model to be caused to have a high correlation with the viscosity of the liquid crystal material, which is the physical properties that change most depending on temperature.

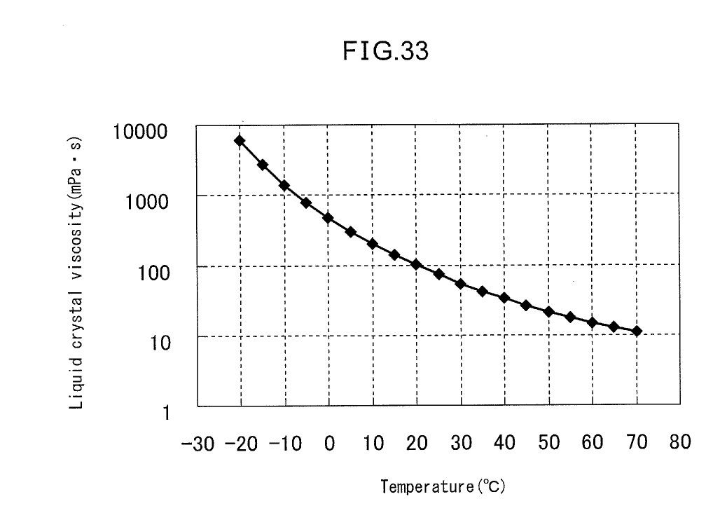

FIG. 33 is a diagram illustrating a relationship between the change in temperature and the change in viscosity of the liquid crystal material. As illustrated schematically, it may be seen that when the temperature is low, the viscosity is high and as the temperature rises, the viscosity reduces.

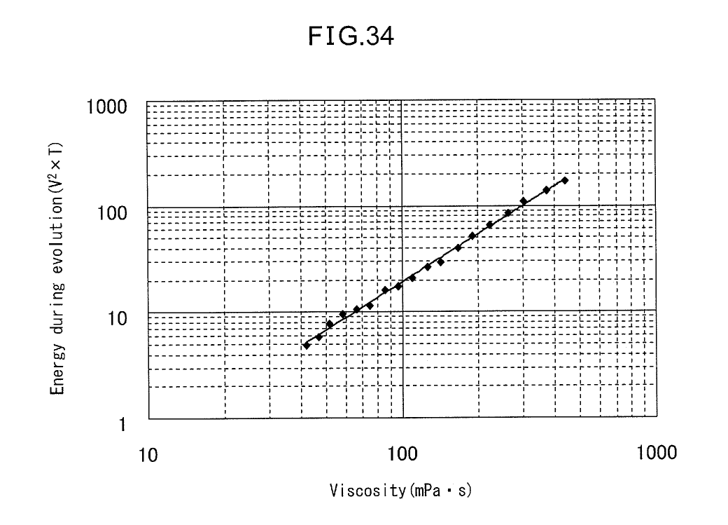

FIG. 34 is a diagram illustrating a correspondence relationship between the viscosity of the liquid crystal material and the energy during the evolution period with which the highest contrast is obtained when the liquid crystal material is driven by the dynamic drive method. The energy during the evolution period is a value obtained by multiplying the square of voltage during the evolution period by the application time. The range of the viscosity of the liquid crystal material illustrated in FIG. 34 is the range of the change in viscosity when the temperature is 3° C. to 37° C. in FIG. 33.

From FIG. 34, it may be seen that the energy during the evolution period with which the highest contrast is obtained at each temperature has a high correlation, substantially a linear relationship, with the viscosity of the liquid crystal material. That is, it is known that if the voltage and application time during the evolution period obtained by the optimization processing at a certain temperature are determined, the voltages and application times at other temperatures may be calculated using the correlation in FIG. 33 and FIG. 34.

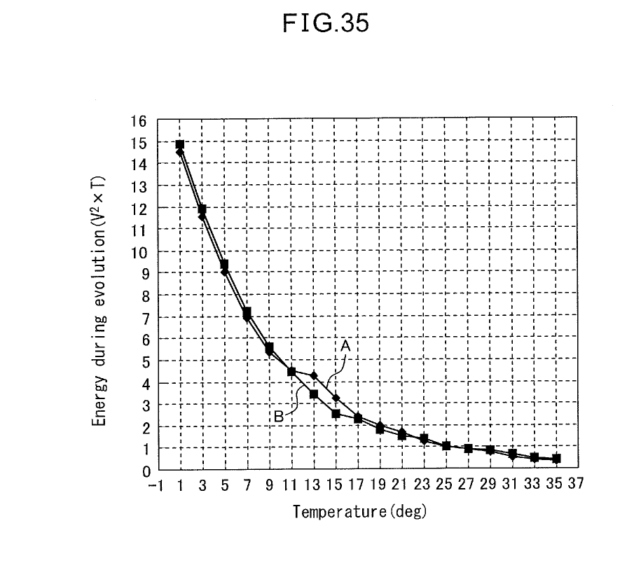

FIG. 35 is a diagram illustrating the change with temperature in the relative value of the energy during evolution period when a high contrast is obtained of two liquid crystal display elements A and B in different manufacturing lots. The manufacturing dates of the two liquid crystal display elements A and B are significantly different and the optimum values of the drive condition are different, however, it may been seen that the relative value of the energy during the evolution period when a high contrast is obtained changes similarly in accordance with the change in temperature. It is known that even if the drive conditions vary from panel to panel, the relative value of the optimum energy during the evolution period illustrates a similar change with temperature regardless of the variations. Consequently, it is possible to perform temperature correction for any liquid crystal display elements different from one another by making use of the temperature change characteristics of the energy during the evolution period if relative correction is performed.

To explain with a specific example, a case is considered where the optimum voltages are somewhat different, i.e., the voltage during the evolution period of the panel A obtained by the optimization processing performed at 25° C. in second step S2 of FIG. 16 is ±25 V and the application time is 15 ms, and the voltage during the evolution period of the panel B is ±24 V and the application time is 15 ms. In this case, the ratio of energy during the evolution period between the panel A and the panel B is 1:0.92, and therefore, it is sufficient to set the drive conditions at other temperatures in such a manner that a high correlation with the viscosity of the liquid crystal material is maintained while maintaining this ratio.

As described above, when developing the drive condition obtained at a certain temperature to the entire temperature range, the temperature dependence of the energy during the evolution period (square of voltage×application time) is determined in advance and the voltages and the application times during the evolution period at other temperatures are determined based on the result of the optimization processing performed at a certain temperature. However, if one of the voltage and the application time is fixed, not depending on the temperature, the processing may be simplified, and therefore, in the first embodiment, the application time is fixed regardless of the temperature and manufacturing lot and the voltage at each temperature is changed.

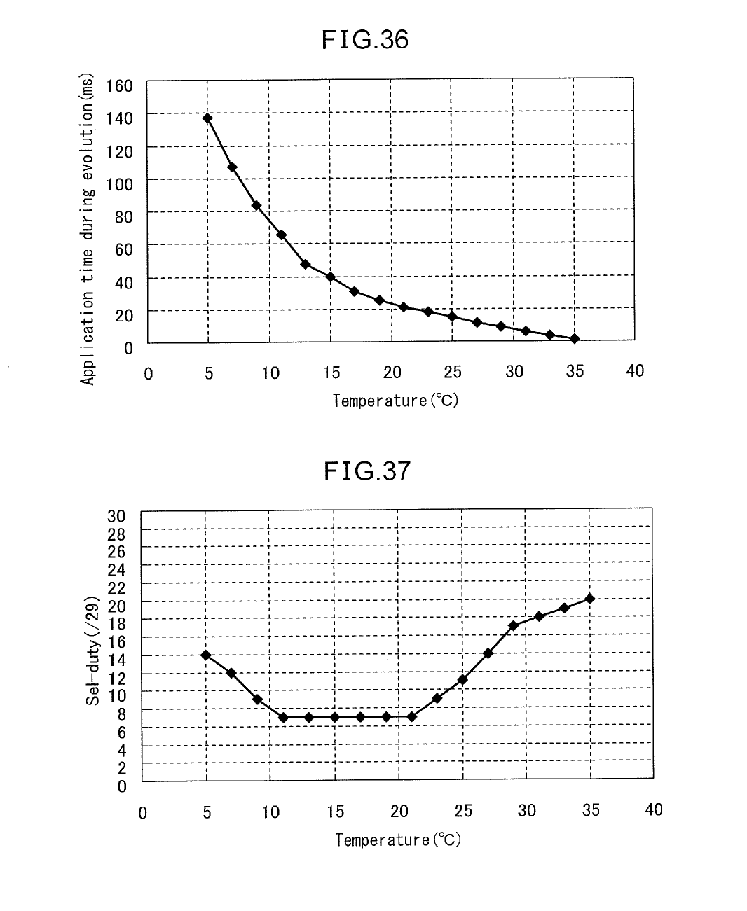

FIG. 36 is a diagram illustrating a relationship between the temperature and the voltage during the evolution period when the application time during the evolution period is fixed and the voltage during the evolution period is changed so that the temperature dependence of the energy during the evolution period of FIG. 35 is satisfied in the first embodiment.

It is advisable to make use of the energy during the selection period similarly in the gamma (gradation characteristics) optimization performed in third step S3. For example, in the case of a 4096-color display, each of RGB having 16 gradations, a relative ratio of the energy (square of voltage×application time) obtained from the voltage and the application time during the evolution period to reproduce 16 gradations of each of RGB is used. In this case, the duty ratio of the white display is the maximum (100%), the duty ratio of the black display is minimum (0%), and the duty ratio of a halftone is a ratio therebetween.

However, the optimization of contrast has a high correlation with the viscosity of the liquid crystal material, and therefore, it is easy to extend the optimization to the drive condition at each temperature. However, as will be described later, as to the optimization of gamma, it is somewhat difficult to grasp the correlation with the viscosity of the liquid crystal material. Therefore, in the first embodiment, as to the energy during the selection period, a model is created by grasping the tendency by experiment rather than simply grasping the tendency by the viscosity of the liquid crystal material.

An example of green, one of colors of RGB, is explained.

It has been made clear that the duty ratio during the selection period with which the center gradation (=8/15) of the 16 gradations of green is obtained has temperature dependence as illustrated in FIG. 37. From FIG. 37, it may be seen that the duty ratio to obtain the center gradation is high on the side of lower temperatures equal to or lower than 10° C. and on the side of higher temperatures equal to or higher than 25° C. It other words, it may be said that a large duty ratio is adequate for the lower temperature side and the higher temperature side because of the characteristics that tend to produce a darker display. The duty ratio represents the application time of the applied pulse during the selection period. Because of that, the energy is calculated from the voltage and application time of the applied pulse during the selection period and by using the energy ratio, the result of the optimization processing at a certain temperature is extended to the entire temperature range. The voltage, the number of lines, and the non-select voltage during the preparation period may be fixed, not depending on temperature, without causing any problem.

In temperature compensation, the temperature range may be divided and the drive condition within each divided range may be changed discretely depending on temperature, however, in such a discrete change of the drive condition, if the temperature is immediately before or after the boundary, the display quality changes suddenly. Therefore, in the first embodiment, the drive condition is changed continuously using linear interpolation.

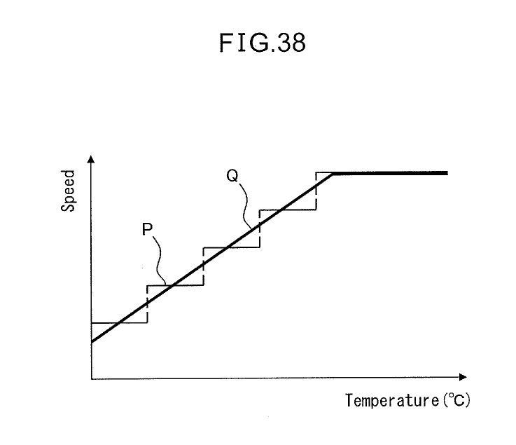

FIG. 38 is a diagram schematically illustrating the changes in rewrite speed when temperature compensation is performed discretely and continuously when the rewrite speed changes by temperature compensation and P illustrates the change when temperature compensation is performed discretely and Q illustrates that when continuously. FIG. 38 illustrates the change in rewrite speed, however, the change in voltage, etc., is the same. In the case of P where temperature compensation is performed discretely, the difference in speed before and after the speed changes becomes large, and therefore, the display quality changes suddenly as a result.

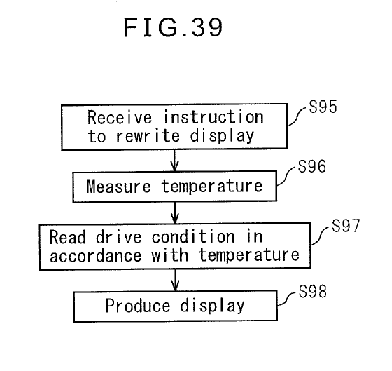

FIG. 39 is a flowchart illustrating the operation when a display is produced in the display device of the first embodiment. In the drive condition storage unit 26, the drive conditions across the entire temperature range are stored.

In step S95, upon receipt of an instruction to rewrite the display, predetermined processing, such as image data reception and gradation conversion, is performed and the data to be displayed is developed and stored in the buffer 25.

In step S96, the temperature of the display device 10 detected by the temperature sensor 27 is read.

In step S97, the drive condition corresponding to the measured temperature is read from the drive condition storage unit 26.

In step 98, the display operation is performed under the read drive condition.

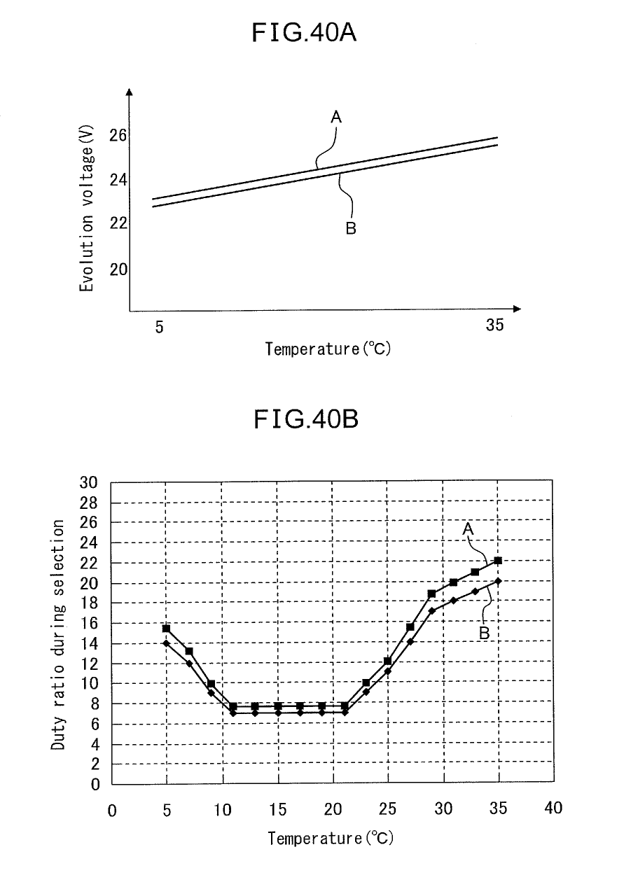

FIG. 40A and FIG. 40B are diagrams illustrating examples in which the drive conditions in the entire temperature range are changed based on the temperature compensation model as to the two liquid crystal display elements A and B in the first embodiment. FIG. 40A illustrates the voltages during the evolution period with respect to temperature and FIG. 40B illustrates the duty ratios during the selection period with respect to temperature.

The optimum values of the liquid crystal display elements A and B are different, however, as described previously, the optimum values have a certain tendency with respect to temperature, and therefore, the optimum values as illustrated in FIG. 40A and FIG. 40B are obtained, respectively.

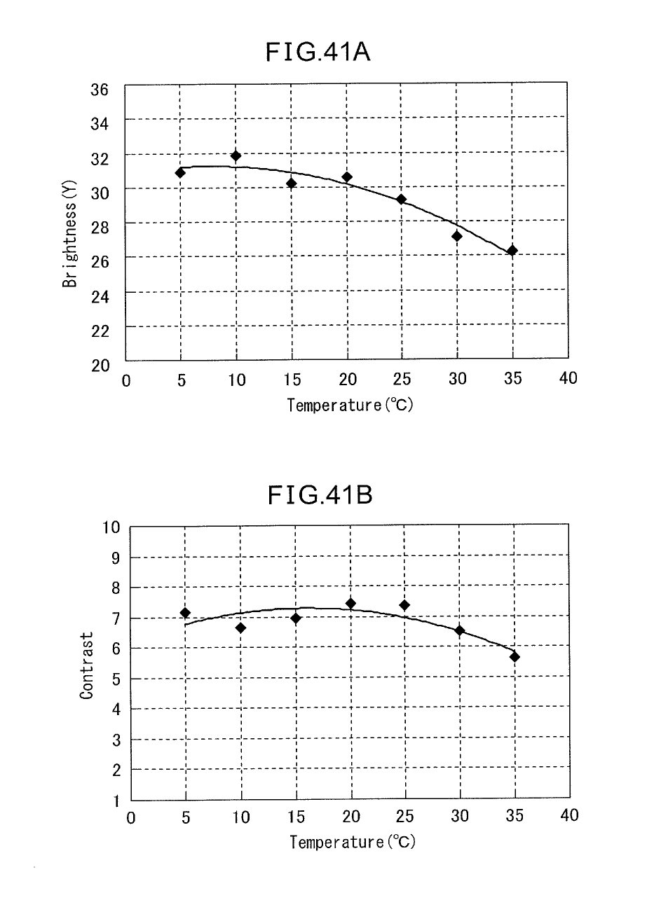

FIG. 41A and FIG. 41B are diagrams illustrating changes in the display characteristics with respect to temperature in the display device of the first embodiment. FIG. 41A illustrates the change in brightness as the temperature changes and FIG. 41B illustrates the change in contrast as the temperature changes. As illustrated schematically, high values of both brightness and contrast are obtained across the wide temperature range and the maximum performance of the display element has been achieved. FIG. 41A and FIG. 41B illustrate the data of one display element, however, the same data has been obtained when another display element is used and the maximum display characteristics have been achieved similarly.

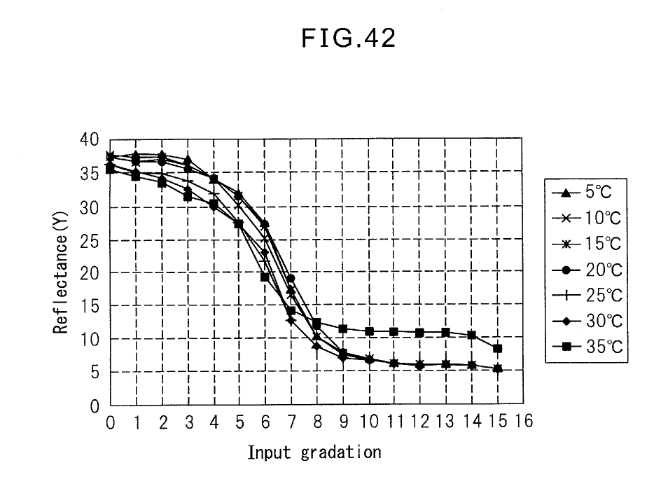

FIG. 42 is a diagram illustrating the change in gamma (gradation characteristics) with respect to temperature in the display device of the first embodiment.

There is a slight deviation between the lowest temperature (5° C.) and the highest temperature (35° C.), however, it may be seen that there is no gradation reverse at each temperature. Further, it has been confirmed that stable display quality is obtained visually.

In the examples illustrated in FIG. 40A to FIG. 42, the automatic adjustment of the drive condition is performed at 25° C. and the drive conditions at temperatures other than 25° C. are determined using the above-mentioned technique based on the drive condition at 25° C.

As described above, in the display device of the first embodiment, the same effect is obtained even when the automatic adjustment of the drive condition is performed any number of times as long as the temperature is in the operating temperature range, and therefore, the automatic adjustment of the drive condition is not performed frequently and usability is improved significantly.

There is a case where the optimum drive condition of each element of RGB is different, and therefore, it may also be possible to perform the above-described automatic adjustment for each element of RGB, individually.

As described previously, it may also be possible to perform the automatic adjustment of the drive condition when starting the product for the first time, to automatically perform periodically (for example, once a moth), or to perform in response to a user's instruction.

In the first embodiment, the electrostatic capacitance values (C0′ and C100′) are measured and when the difference between the measured electrostatic capacitance value and the stored electrostatic capacitance measured by the previous drive condition automatic adjustment processing is large, the drive condition automatic adjustment processing is performed again and when the difference is small, part of the drive condition automatic adjustment processing, for example, the setting processing of the evolution voltage is omitted. However, when the difference between the measured electrostatic capacitance value and the stored electrostatic capacitance measured by the previous drive condition automatic adjustment processing is sufficiently small, the change in the panel characteristics is small and in many cases, the evolution value or the PWM-Duty ratio is not changed. In such a case, the evolution voltage or the PWM-Duty ratio is not changed, in other words, the drive condition automatic adjustment processing is not performed.

A display device of a second embodiment, to be explained next, has the same hardware configuration as that of the display device of the first embodiment and differs only in that the start of the second and subsequent drive condition automatic adjustment processing is determined.

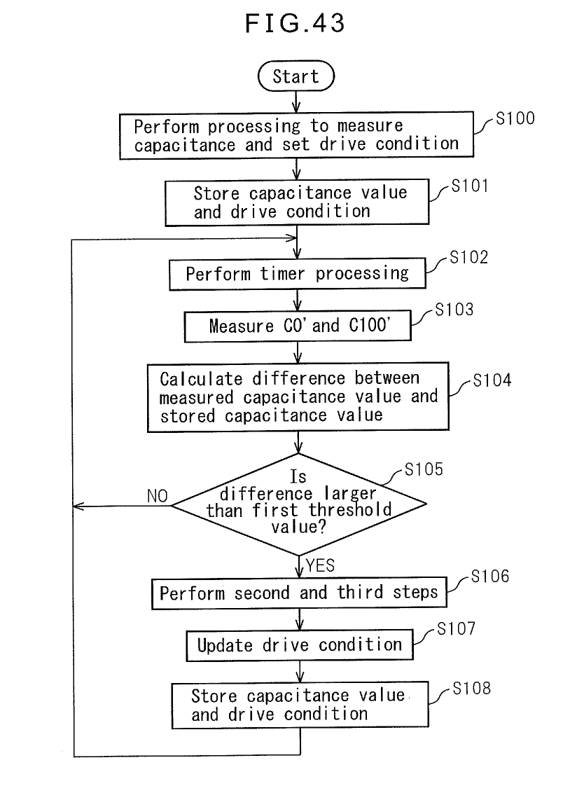

FIG. 43 is a flowchart illustrating drive condition automatic adjustment processing of the display device of the second embodiment.

In step S100, the drive condition automatic adjustment processing illustrated in FIG. 16 is performed once in advance, the electrostatic capacitances corresponding to the white display and the black display are measured, and the evolution voltage and the duty ratio of the selection pulse with which the target electrostatic capacitance value is obtained are determined.

In step S101, the control unit 23 stores the electrostatic capacitances (C0′ and C100′) measured by the drive condition automatic adjustment processing and the evolution voltage and the duty ratio of the selection pulse that are set in the drive condition storage unit 26.

In the second embodiment, the drive condition is changed in accordance with the secular change and the change in environment, and therefore, the drive condition automatic adjustment processing is started periodically.

Therefore, in step S102, timer processing is performed and the elapse of a predetermined time is detected. The processing is not limited to the timer processing and it is also possible to start the drive condition automatic adjustment processing in accordance with other factors, such as a change in temperature, and combinations thereof, and to receive a signal to start the drive condition automatic adjustment processing from outside.

In step S103, the same processing as that in S6 of FIG. 24 is performed. Due to this, the electrostatic capacitance values C0′ and C100′ corresponding to the 0% point and the 100% point are measured.

In step S104, the differences D0 and D100 between the electrostatic capacitance values C0′ and C100′ measured in S103 and the previous electrostatic capacitance values stored in S101 are calculated, respectively. D0 is the absolute value of the difference between the electrostatic capacitance value C0′ measured in S103 and C0′ stored in S101 and D100 is the absolute value of the difference between the electrostatic capacitance value C100′ measured in S103 and C100′ stored in S101.

In step S105, whether the difference is larger than a first threshold value is determined and when the determination result is affirmative, the procedure proceeds to step S106 and when negative, the procedure returns to step S102. When the procedure returns to step S102, the state is maintained until the next start signal is generated. In other words, the drive condition automatic adjustment processing is not performed. As described above, when the change in the electrostatic capacitance values C0′ and C100′ is sufficiently small, the change in the panel characteristics is small, and therefore, the evolution voltage or the PWM-Duty ratio it is not changed and not performing the drive condition automatic adjustment processing does not cause a problem.

In step S106, second step S2 and third step S3 of FIG. 16 are performed and the evolution voltage and the PWM-Duty ratio are set. At this time, it is possible to perform processing to reduce the processing time explained in the first embodiment.

In step S107, the temperature of the display device 10 is measured and the drive conditions in the entire temperature range are updated based on the temperature and the temperature compensation model.

In step S108, the electrostatic capacitance values C0′ and C100′ measured in S103 and the drive conditions in the entire temperature range, such as the evolution voltage and the PWM-Duty ratio that are updated, are stored in the drive condition storage unit 26 and then the procedure returns to step S102.

In the display device of the first embodiment, the DDS drive system is used, however, when the previously-described conventional drive system is used, it is also possible to apply the technique in which the electrostatic capacitance of the display device is detected in a different display state and the drive condition is adjusted based on the detected electrostatic capacitance. A display device of a third embodiment that uses the conventional drive system is explained below.

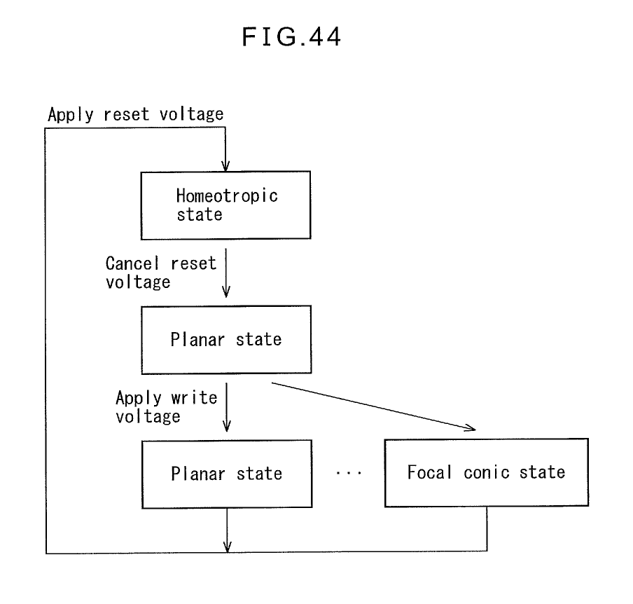

FIG. 44 is a diagram illustrating the change in the display state in the display device of the third embodiment.

When a strong electric field (reset voltage) is applied, the cholesteric liquid crystal enters the homeotropic state where all the liquid crystal molecules align in the direction of the electric field and when the application of the electric field is cancelled suddenly in the homeotropic state, the cholesteric liquid crystal enters the planar state. In the planar state, when an intermediate electric field (write voltage) is applied, the planar state changes to the focal conic state, however, depending on the application time, the ratio of liquid crystal molecules that change to the focal conic stage differs. Specifically, when the application time is short, the ratio of the focal conic state is small and when the application time is long, the ratio of the focal conic state is large.

With the conventional drive system, it is possible to produce a halftone display with high evenness, which is difficult with the DDS drive system, and the conventional drive system is useful when it is desired to produce a display close to a full-color display.

The display device of the third embodiment has the same configuration as that illustrated in FIG. 1 and differs from that of the first embodiment in that the segment driver 11 and the common drive 12 using the simple matrix system are used and in that the drive system is the conventional system. The display device using the cholesteric liquid crystal using the conventional drive system is widely known, and therefore, detailed explanation is omitted, however, related items are explained briefly.

In the conventional drive system, after bringing about the homeotropic state by applying the reset voltage to all the pixels of target of rewrite, the reset processing to bring about the planar state by cancelling the application of the reset voltage and the write processing to apply a write pulse to each pixel and to display an image by adjusting the application time are performed.

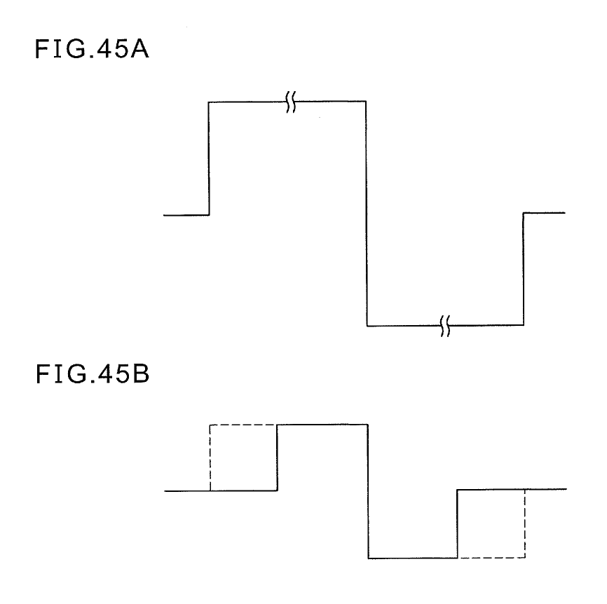

FIG. 45A illustrates a reset pulse to be applied to all the pixels at the time of reset processing and for example, a ±36 V pulse with a width of tens of millimeters.

As described above, the mixture ratio of the focal conic state changes in accordance with the application time of the write voltage. The method for changing the application time of the write voltage is roughly divided into two methods. A first method is a method for changing the application time by the width of the pulse and a second method is a method for changing the application time by the number of accumulated short pulses.

FIG. 45B illustrates a write pulse when the first method is performed. The write pulse is a ±20 V pulse and the pulse width is different. Specifically, the common driver 12 applies a scan pulse to each scan line and shifts the position of the scan line to which the scan pulse is applied one by one. The period of the scan pulse applied to one line is the maximum pulse width of the write pulse. The segment driver 12 outputs a signal to control on/off of the write pulse in synchronization with application of the scan pulse. Due to this, the write to all of the pixels in one scan line to which the scan pulse is applied is performed. To the pixel that maintains the planar state (white display), the scan pulse is not applied, to the pixel to be brought into the focal conic state (black display), the scan pulse with a width corresponding to the period of the scan pulse is applied, and to the pixel that displays a halftone, the scan pulse with a pulse width in accordance with the gradation is applied.

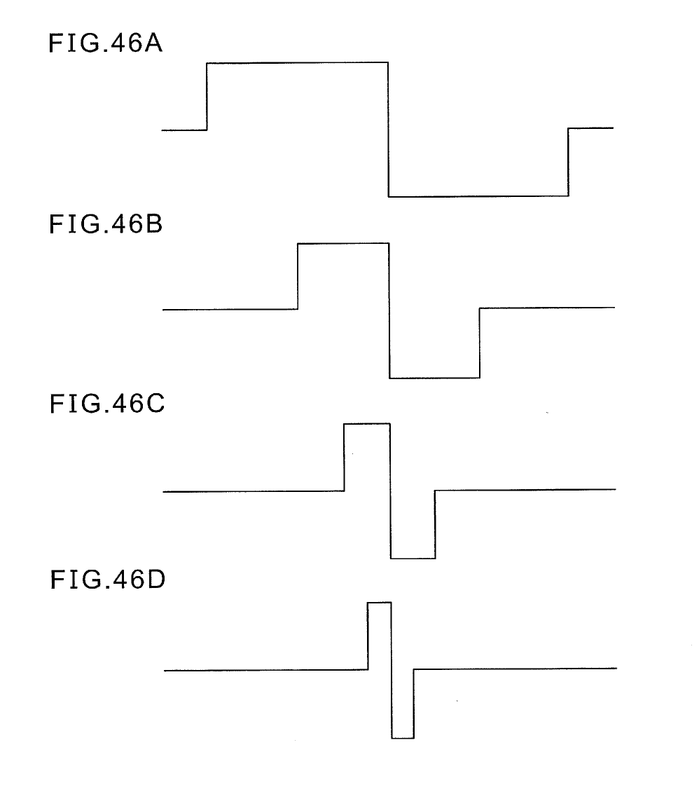

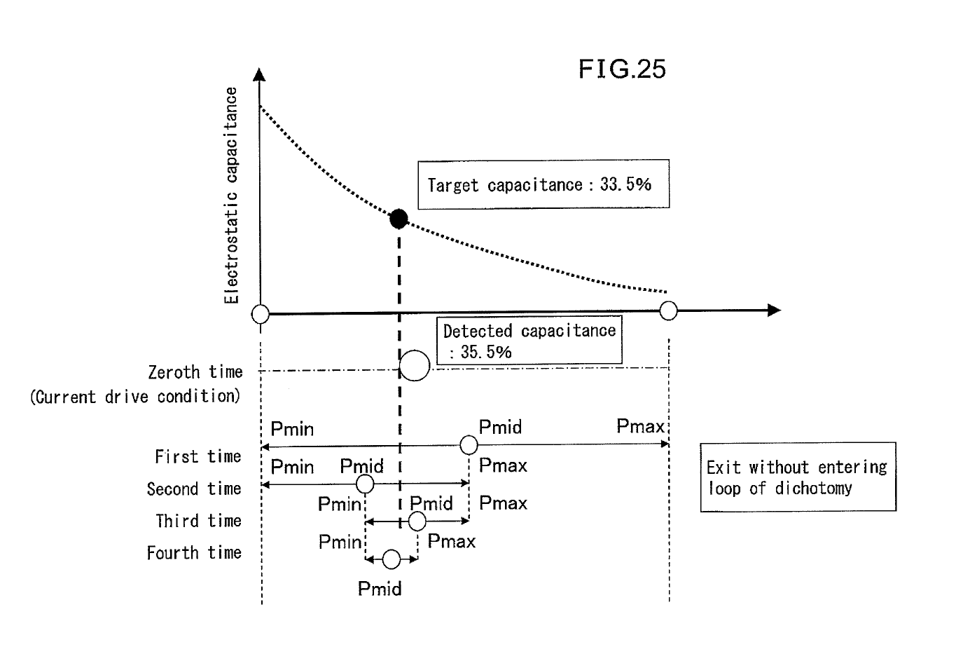

FIG. 46A to FIG. 46D illustrate write pulses when the first method is performed and the pulses of FIG. 46A to FIG. 46D are applied in four frames. The widths of the write pulses of FIG. 46A to FIG. 46D are halved in order. In the first frame, the common driver 12 applies a scan pulse corresponding to the write pulse of FIG. 46A to each scan line and shifts the position of the scan line to which the scan pulse is applied one line each time. In synchronization with the application of the scan pulse, the segment driver 12 outputs a signal to control on/off of the write pulse. In the same manner, the application of the write pulses of FIG. 46B to FIG. 46D is performed. To the pixel in which only the write pulse of FIG. 46A is on, the write pulse with a width of 8 is applied, to the pixel in which only the write pulse of FIG. 46B is on, the write pulse with a width of 4 is applied, and so on. Consequently, to the pixel in which all the write pulses of FIG. 46A to FIG. 46D are on, the write pulse with the maximum width of 15 is applied and to the pixel in which none of the write pulses is on, no write pulse is applied.

In the display device of the third embodiment, the parameters adjusted in the drive condition are, for example, the voltage of the write pulse in the write processing, the maximum accumulated time of the write pulse, the pulse width, etc. While measuring the electrostatic capacitance of the display element the display state of which is set, these parameters are optimized by applying the Newton's method, the dichotomy, etc. Further, the drive conditions in the entire temperature range are found and stored by changing the voltage and/or the pulse width of the pulse so that the energy of each pulse changes in accordance with temperature along a curve similar to that illustrated in FIG. 36.

As explained above, in the first to third embodiments, the automatic adjustment of the drive condition is performed and it is made possible to optimize the drive conditions in the entire temperature range at one time, and therefore, it is possible to reduce the substantial response time.

All examples and conditional language provided herein are intended for pedagogical purposes of aiding the reader in understanding the invention and the concepts contributed by the inventor to furthering the art, and are to be construed as limitations to such specifically recited examples and conditions, nor does the organization of such examples in the specification relate to a illustrating of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A display device comprising:
a display element having memory properties configured to maintain a display state after being driven and then the drive is cancelled;
an electrostatic capacitance detection circuit configured to detect an electrostatic capacitance exhibited by the display element;
a temperature sensor configured to detect the temperature of the display element; and
a control unit configured to control the drive of the display element, wherein
the control unit comprises:
a drive condition adjustment circuit configured to adjust the drive condition of the display element based on the electrostatic capacitance detected in the display state where the display element is driven under a predetermined drive condition; and
a temperature compensation storage circuit storing one or more temperature compensation models indicating a correspondence relationship of the drive condition with which the display element has the optimum display characteristics across a predetermined temperature range, and
the control unit changes the drive conditions of the display element at temperatures other than the temperature when the adjustment is performed based on:
the temperature when the drive condition of the display element is adjusted; and the temperature compensation model.

2. The display device according to claim 1, wherein
the temperature compensation storage circuit comprises a lookup table which stores the values of the correspondence relationship of the temperature compensation model.

3. The display device according to claim 1, wherein
the display element uses cholesteric liquid crystal.

4. The display device according to claim 3, wherein
the display element is driven by the dynamic driving scheme (DDS).

5. The display device according to claim 4, wherein
the drive condition adjustment circuit automatically adjusts, after automatically adjusting the drive condition using the voltage value during the evolution period as a parameter, the drive condition using the duty ratio during the selection period as a parameter under the condition that the adjusted voltage value is used.

6. The display device according to claim 5, wherein
the drive condition adjustment circuit adjusts the voltage value during the evolution period and the duty ratio during the selection period, respectively, by applying the dichotomy.

7. The display device according to claim 6, wherein
the drive condition adjustment circuit performs adjustment so that the electrostatic capacitance at the time of the measurement by changing the duty ratio during the selection period becomes close to a target electrostatic capacitance and stops the adjustment when a difference between the measured electrostatic capacitance and the target electrostatic capacitance becomes equal to or less than ±100/2(N−1) in the case of producing an N-gradation display.

8. The display device according to claim 4, wherein
the temperature compensation model is a model configured to modulate the energy of a pulse to be applied during the evolution period in accordance with temperature.

9. The display device according to claim 4, wherein
the temperature compensation model is a model configured to modulate the energy and duty ratio of a pulse to select a halftone to be applied during the selection period in accordance with temperature.

10. The display device according to claim 1, wherein
the drive condition adjustment circuit automatically adjusts the drive condition of the display element based on the electrostatic capacitances detected in at least two or more different display states.

11. The display device according to claim 1, wherein
the electrostatic capacitance detection circuit comprises:
a current detection waveform application circuit configured to generate a signal having a current detection waveform and apply the signal to the display element; and
a current detection circuit configured to detect the value of a current to the display element when the signal having the current detection waveform is applied.

12. The display device according to claim 11, wherein
the current detection waveform is a saw-tooth wave or a triangular wave.

13. The display device according to claim 11, wherein
the current detection circuit is arranged so as to measure a current to be supplied to a segment driver configured to drive the display element by the simple matrix system.

14. The display device according to claim 1, wherein
the detection of the electrostatic capacitance by the electrostatic capacitance detection circuit is performed by applying a signal having a current detection waveform to the display element after setting the entire screen of the display element to a predetermined display state.

15. The display device according to claim 1, wherein
the detection of the electrostatic capacitance by the electrostatic capacitance detection circuit is performed by applying a signal having a current detection waveform to each region after dividing the display screen of the display element into regions in correspondence to the output terminals of the segment driver and setting the display screen of the display element to a predetermined display state for each region.

16. The display device according to claim 1, wherein
the drive condition adjustment circuit comprises:
an A/D converter configured to convert the current value detected by the current detection circuit into a digital value; and
an arithmetic circuit configured to calculate the drive condition based on the digital value output from the A/D converter.

17. The display device according to claim 1, wherein
the display element comprises a stacked structure of a plurality of liquid crystal layers that exhibit different reflected light, and
the drive condition adjustment circuit automatically adjusts the drive condition for each layer.

18. The display device according to claim 1, wherein
the drive condition adjustment circuit comprises an electrostatic capacitance storage circuit configured to store the electrostatic capacitance of the display element at the time of the previous adjustment,
the drive condition adjustment circuit performs adjustment processing by the drive condition adjustment circuit when a difference between the electrostatic capacitance detected by the electrostatic capacitance detection circuit and the electrostatic capacitance stored in the electrostatic capacitance storage circuit is equal to or more than a predetermined value, and
the control unit changes the drive conditions of the drive condition table.

19. The display device according to claim 1, wherein
the detection of the electrostatic capacitance by the electrostatic capacitance detection circuit is performed periodically.

20. A drive control method of a display element having memory properties configured to maintain a display state after being driven and then the drive is cancelled, the method including:
detecting the electrostatic capacitance exhibited by the display element in a set display state after setting the display state by driving the display element under a predetermined drive condition;
automatically adjusting the drive condition of the display element based on the detected electrostatic capacitance;
detecting the temperature of the display element; and
changing the drive conditions of the display element to temperatures other than the temperature when the adjustment is performed based on the detected temperature and a temperature compensation model.
